(19) United States
(12) Patent Application Publication
(10) Pub. No.: US 2016/0043848 A1
(43) Pub. Date: Feb. 11, 2016

(54) METHOD AND DEVICE FOR SENDING AND RECEIVING DEMODULATION REFERENCE SIGNAL ON NEW CARRIER TYPE (NCT) CARRIER

(71) Applicant: INTELLECTUAL DISCOVERY CO., LTD., Seoul (KR)

(72) Inventor: Sun Woo KIM, Seoul (KR)

(73) Assignee: INTELLECTUAL DISCOVERY CO., LTD., Seoul (KR)

(21) Appl. No.: 14/773,672

(22) PCT Filed: Mar. 7, 2014
(86) PCT No.: PCT/KR2014/001912

§ 371 Date: Sep. 8, 2015

(30) Foreign Application Priority Data
Mar. 8, 2013 (KR) 10-2013-0024910
Apr. 24, 2013 (KR) 10-2013-0045501
Apr. 26, 2013 (KR) 10-2013-0046670

(51) Int. Cl. H04L 5/00; H04L 5/14; H04W 72/04

(52) U.S. Cl. CPC H04L 5/0051; H04L 5/0016; H04W 72/042; H04L 5/14; H04L 5/1469

(57) ABSTRACT

The present invention relates to a NCT in which there is no control region comprising a PDCCH. And, a method according to one embodiment of the present invention, wherein a base station sends a demodulation reference signal having orthogonality on a carrier which is NCT, comprises: a step wherein code-division multiplexing is carried out by using orthogonal code with respect to the demodulation reference signal which maps onto a symbol that overlaps PSS and SSS disposed in a carrier downlink subframe; and a step of sending a downlink comprising the demodulation reference signal in which the code-division multiplexing has been used.

### TECHNICAL FIELD

The present invention relates to a new carrier type (NCT) in which a control region comprising a Physical Downlink Control Channel (PDCCH) does not exist, and more specifically to methods and devices for transmitting and receiving a demodulation reference signal (DM-RS) in a NCT carrier.

### BACKGROUND ART

According to advances of communication systems, users such as individuals and companies are using various types of wireless terminals. Current mobile communication systems such as Long Term Evolution (LTE) and LTE-Advanced of 3GPP are high-speed and large-capacity communication systems capable of transmitting and receiving a variety of data such as video, wireless data, etc. as well as voice, and developments of technologies which can transmit a large amount of data equal to those of wired communication networks. As a method for transmitting a large amount of data, a method of effectively transmitting data by using a plurality of component carriers may be utilized.

In such the system, time-frequency resources may be divided into a region through which a control channel (e.g., Physical Downlink Control Channel (PDCCH)) is transmitted, and a region through which a data channel (e.g., a Physical Downlink Shared Channel (PDSCH)) is transmitted.

In order to improve performance of mobile communication system, technologies such as a Multiple-Input Multiple-Output (MIMO) and a Coordinated Multi-point Transmission/Reception (CoMP) are considered.

Also, for a carrier of new carrier type (NCT) in which there is no control region comprising PDCCH, which is added as a new work item for a release 12 of 3GPP, main issues such as a problem of collision between PSS/SSS and DM-RS, a problem of radio resource measurement (RRM) on NCT carriers, synchronized new carriers, etc. are being discussed.

### DISCLOSURE

### Technical Problem

The present invention provides methods of changing positions of DM-RS and changing transmission patterns of DM-RS for evading collisions between DM-RS and PSS/SSS when PSS/SSS exists in a NCT carrier.

Also, the present invention provides methods of evading collisions between DM-RS and PSS/SSS while maintaining conventional positions of PSS/SSS and DM-RS.

### Technical Solution

In accordance with an example embodiment of the present invention, a method may be provided for transmitting a demodulation reference signal having orthogonality in a new carrier type (NCT) carrier, in a base station. The method may comprise performing code division multiplexing on a demodulation reference signal to be mapped onto a symbol overlapped with a Primary Synchronization Signal (PSS) and a Secondary Synchronization Signal (SSS) positioned in a downlink subframe of the carrier by using an orthogonal code; and transmitting the demodulation signal to which the code division multiplexing is applied through downlink.

In accordance with another example embodiment of the present invention, a method may be provided for receiving a demodulation reference signal having orthogonality in a new carrier type carrier, in a terminal. The method may comprise receiving a downlink signal including the demodulation reference signal; and identifying the demodulation reference signal located in a downlink subframe of the carrier by using an orthogonal code, wherein the demodulation reference signal is mapped to a symbol overlapped with a Primary Synchronization Signal (PSS) and a Secondary Synchronization Signal (SSS) positioned in the downlink subframe of the carrier, and the PSS, the SSS, and the demodulation reference signal are code-division-multiplexed.

In accordance with still another example embodiment of the present invention, a base station may be provided for transmitting a demodulation reference signal having orthogonality in a new carrier type (NCT) carrier. The base station may comprise a receiving part receiving signals from a terminal, a control part performing code division multiplexing on the demodulation reference signal to be mapped onto symbols overlapped with PSS/SSS located in a downlink subframe of the carrier by using an orthogonal code; and a transmitting part transmitting the downlink subframe including the demodulation reference signal to which the code division multiplexing is applied.

In accordance with still another example embodiment of the present invention, a method may be provided for transmitting a demodulation reference signal in a new carrier type carrier, in a base station. The method may comprise mapping the demodulation reference signal onto a symbol which is temporally different from a Primary Synchronization Signal (PSS) and a Secondary Synchronization Signal (SSS) positioned in a downlink subframe of the carrier; and transmitting the downlink subframe including the demodulation reference signal.

In accordance with still another example embodiment of the present invention, a method may be provided for receiving a demodulation reference signal having orthogonality in a new carrier type carrier, in a terminal. The method may comprise receiving a downlink subframe including the demodulation reference signal; and identifying the demodulation reference signal mapped onto symbols which are temporally different from a Primary Synchronization Signal (PSS) and a Secondary Synchronization Signal (SSS) positioned in the downlink subframe of the carrier.

In accordance with still another example embodiment of the present invention, a base station may be provided for transmitting a demodulation reference signal in a new carrier type carrier. The base station may comprise a control part mapping the demodulation reference signal onto symbols which are temporally different from a Primary Synchronization Signal (PSS) and a Secondary Synchronization Signal (SSS) positioned in a downlink subframe of the carrier; a transmitting part transmitting the downlink subframe including the mapped demodulation reference signal; and a receiving part receiving signals from a terminal receiving the downlink subframe.

### Advantageous Effects

According to the present invention, without changing positions of PSS/SSS and DM-RS in a NCT carrier, collisions between PSS/SSS and DM-RS can be evaded by code-division-multiplexing PSS/SSS and DM-RS.

Also, even when PSS/SSS exists in a NCT carrier, collisions between PSS/SSS and DM-RS can be evaded by changing positions onto which DM-RS are mapped.

### DESCRIPTION OF DRAWINGS

FIG. 1 illustrates a communication system to which example embodiments of the present invention are applied.

FIG. 2 illustrates a control region through which control channels including PDCCH, PCFICH, and PHICH are transmitted, and a data region through data channel including PDSCH is transmitted, in a subframe.

FIG. 3 illustrates an ePDCCH implementation to which an example embodiment of the present invention is applied.

FIG. 4 illustrates a distributed transmission and a localized transmission of ePDCCH.

FIG. 5 illustrates positions of PSS/SSS OFDM symbols in cases of FDD and TDD.

FIG. 6 illustrates positions of PBCH OFDM symbol.

FIG. 7 illustrates positions of subcarriers (resource elements) of PSS/SSS and PBCH for each of cases that a system bandwidth is 20 MHz, 10 MHz, 5 MHz, 3 MHz, or 1.4 MHz.

FIG. 8 illustrates symbol-based cyclic shifted eREG indexing for a PRB pair when ePDCCH is used as a NCT structure and a CRS port 0 is configured.

FIG. 9 illustrates collisions between PSS/SSS and DM-RS.

FIG. 10 illustrates a code division multiplexing of PSS/SSS and DM-RS according to an example embodiment of the present invention.

FIG. 11 illustrates an operation procedure of a base station according to an example embodiment of the present invention.

FIG. 12 is a diagram showing an operation procedure of a terminal according to an example embodiment of the present invention.

FIG. 13 is a diagram showing a configuration of a base station according to an example embodiment of the present invention.

FIG. 14 is a diagram showing a configuration of user equipment according to an example embodiment of the present invention.

FIG. 15 is a diagram showing a procedure of transmitting a demodulation reference signal in a base station according to another example embodiment of the present invention.

FIG. 16 is a diagram showing a procedure in which a terminal according to another example embodiment of the present invention receives a demodulation reference signal.

FIG. 17 is a diagram illustrating intra-frequency RRM measurement having 2 ms on-duration periods and 40 ms DRX periods on two adjacent NCT cells having 5 ms transmission cycles.

FIG. 18 is a diagram showing DM-RS patterns for a normal CP subframe according to an example embodiment of the present invention.

FIGS. 19 to 21 illustrate CSI-RS patterns in which CSI-RS is configured.

FIG. 22 is a diagram showing DM-RS patterns for a normal CP subframe and an extended CP subframe, in case of FDD, according to an example embodiment of the present invention.

FIG. 23 and FIG. 24 are diagrams illustrating DM-RS patterns for a normal CP subframe and an extended CP subframe, in case of TDD, according to an example embodiment of the present invention.

FIG. 25 is a diagram showing a configuration of a base station according to another example embodiment of the present invention.

FIG. 26 is a diagram showing a configuration of user equipment according to another example embodiment of the present invention.

### BEST MODE

Hereinafter, exemplary embodiments of the present invention will be described with reference to the accompanying drawings. In the following description, the same elements will be designated by the same reference numerals although they are shown in different drawings. Furthermore, in the following description of the present embodiment, a detailed description of known functions and configurations incorporated here will be omitted when it may make the subject matter of the present embodiment unclear.

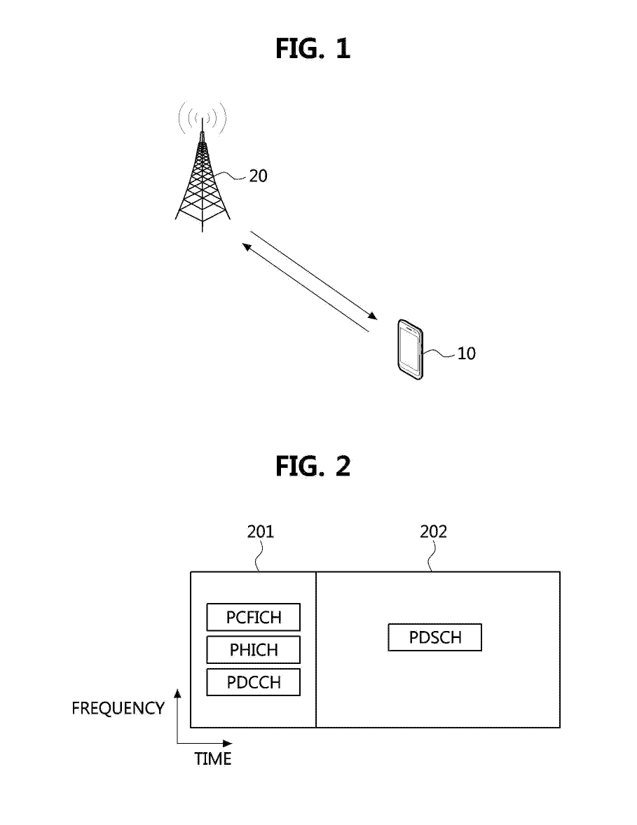

FIG. 1 illustrates a communication system to which example embodiments of the present invention are applied.

The communication system may be deployed widely in order to provide a variety of communication services such as a voice service, a packet data service, and so forth.

Referring to FIG. 1, the communication system may include user equipment (UE) 10 and a transmission point 20 which performs uplink and downlink transmissions with the UE 10.

The terminal or UE 10 in the present specification may be understood as a general concept that includes a mobile station (MS), a user terminal (UT), a subscriber station (SS), and/or a wireless device in a global system for mobile communications (GSM), as well as user equipment used in wideband code division multiple access (WCDMA), long term evolution (LTE), and/or high speed packet access (HSPA).

In the present description, the transmission point 20 or the cell may be construed as an inclusive concept indicating a porting of an area or a function covered by a base station controller (BSC) in code division multiple access (CDMA), a Node-B in WCDMA, an eNB or a sector (a site) in LTE, and the like. Accordingly, a concept of the transmission point may include a variety of coverage areas such as a megacell, a macrocell, a microcell, a picocell, a femtocell, and the like. Furthermore, such concept may include a communication range of the relay node (RN), the remote radio head (RRH), or the radio unit (RU).

In the present description, the user equipment 10 and the transmission point 20 may be transmission/reception subjects, having an inclusive meaning, which are used to employ the technology and the technical concept disclosed herein, and may not be limited to a specific term or word.

Although only one terminal 10 and only one transmission point 20 are illustrated in FIG. 1, the present invention is not limited to such the environment. That is, it is possible that a single transmission point 20 communicates with multiple terminals 10 and vice versa.

The communication system may use a variety of multiple access schemes such as CDMA, time division multiple access (TDMA), frequency division multiple access (FDMA), orthogonal frequency division multiple access (OFDMA), OFDM-FDMA, OFDM-TDMA, OFDM-CDMA, and/or the like.

Also, in the case of an uplink transmission and a downlink transmission, the present invention may use a time division duplex (TDD) performing the uplink/downlink transmissions using different times, a frequency division duplex (FDD) performing the uplink/downlink transmissions using different frequencies, or a hybrid duplexing combining the TDD and the FDD.

Specifically, example embodiments of the present invention may be applied to in the field of asynchronous wireless communications evolving to Long Term Evolution (LTE) and LTE-Advanced (LTE-A) through GSM, WCDMA, and HSPA, and in the field of synchronous wireless communications evolving to CDMA, CDMA-2000, and UMB. The present invention should not be construed as being limited to or restricted by a particular communication field, and should be construed as including all technical fields to which the spirit of the present embodiment can be applied.

Referring to FIG. 1, the terminal 10 and the transmission point 20 may perform uplink and downlink communications with each other.

The transmission point 20 may perform downlink transmission to the terminal 10. The transmission point 20 may transmit a physical downlink shared channel (PDSCH), a main physical channel for unicast transmission. Also, the transmission point 20 may transmit control channels such as a physical downlink control channel (PDCCH) for transmission of downlink control information for receiving PDSCH and scheduling grant information for transmitting uplink data channel (e.g., physical uplink shared channel (PUSCH)), a physical control format indicator channel (PCFICH) for transmitting an indicator separating regions of PDSCH and PDCCH, a physical HARQ indicator channel (PHICH) for transmitting acknowledgement of hybrid automatic repeat request (HARQ), etc. Hereinafter, transmission of signals through respective channels is described as transmission of respective channels.

The transmission point 20 may transmit a cell-specific reference signal (CRS), a multicast/broadcast over single frequency network reference signal (MBSFN-RS), an UE-specific reference signal (DM-RS), a positioning reference signal (PRS), and a channel state information reference signal (CSI-RS), in downlink.

On the other hand, a radio frame comprises 10 subframes, and each subframe comprises two slots. Here, the radio frame has a length of 10 ms, and the subframe has a length of 1.0 ms. Usually, a basic unit of data transmission may be a subframe, and uplink or downlink scheduling is performed in units of subframes.

One slot may have a plurality of OFDM symbols in time domain, and at least one subcarrier in frequency domain. For example, one slot may comprise seven symbols (in case of normal cyclic prefix (CP) subframe) or six symbols (in case of extended CP subframe) in time domain, and comprise 12 subcarriers in frequency domain. The time-frequency region defined as a slot may be referred to as a resource block (RB) without being restricted.

FIG. 2 illustrates a control region 201 through which control channels including PDCCH, PCFICH, and PHICH are transmitted and a data region 202 through data channel including PDSCH is transmitted, in a subframe. The horizontal axis of FIG. 2 represents a time axis, and the vertical axis of FIG. 2 represents a frequency axis. FIG. 2 illustrates a single subframe (1 ms) in time axis and a single channel (e.g., 1.4, 3, 5, 10, 15, or 20 MHz) in frequency axis.

The PCFICH may comprise information of two bits corresponding to the number of OFDM symbols which means the size of the control region 201, and they are encoded as a codeword having a length of 32 bits. The encoded bits may be scrambled by using cell-specific or subframe-specific scrambling code in order to randomize inter-cell interferences, and mapped onto 16 resource elements as modulated in Quadrature Phase Shift Keying (QPSK) manner. The PCFICH is always mapped onto the first OFDM symbol of each subframe. The PCFICH mapped to the first OFDM symbol of each subframe is divided into four groups which are distributed in frequency domain so as to obtain better diversity effect.

The PDCCH (control information) is used for transmitting downlink control information (DCI) such as scheduling information and a power control command. For example, DCI formats 0 and 4 are used for uplink grant in LTE/LTE-A. DCI formats 1/1A/1B/1C/1D/2/2A/2B/2C are used for downlink scheduling assignments. Also, DCI formats 3/3A are used for power control.

A cyclic redundancy check (CRC) is attached to each DCI message payload, and a radio network temporary identifier (RNTI) for identifying a terminal is included when calculating the CRC. After attaching CRC, bits are encoded using tail-biting convolutional code, and matched to the amount of resources used for transmission of PDCCH through rate-matching.

The PDCCH may be transmitted in common search space or UE-specific search space of the control region 201. Each terminal 10 may search a common search space allocated to terminals in a cell and a UE-specific search space allocated to it for PDCCH by blind-decoding, and may operate based on control information transferred through the searched PDCCH.

Meanwhile, the LTE/LTE-A system defines uses of multiple component carriers (CC) as a method for extending frequency bandwidth to satisfy system requirements such as high data rate. Here, a CC may have 20 MHz bandwidth, and it is possible to allocate resources within 20 MHz according to corresponding services. However, this is only an example, and a CC may have a bandwidth wider than 20 MHz according to implementations of the system.

Meanwhile, in order to increase data rates, technologies such as Multiple-Input Multiple-Output (MIMO), Coordinated Multiple Point (CoMP), relay node, etc. are being proposed. However, in order to use the above technologies, it is necessary for a transmission point such as a base station to transmit more control information.

However, in case that the size of control region through which PDCCH is transmitted is limited, as a method of increasing transmission capacity of PDCCH, a method of transmitting control information to be transmitted through PDCCH by using the data region through which PDSCH is transmitted may be considered. The above method may support additional PDCCH capacity without reducing reliability of PDCCH reception. Control information corresponding to PDCCH through the PDSCH region may be referred to as extended control information (Extended-PDCCH (EPDCCH), ePDCCH, X-PDCCH, or PDCCH-Advanced (PDCCH-A)). Hereinafter, it is referred to as ePDCCH. ePDCCH may be used as R-PDCCH which is a control channel for a relay. That is, ePDCCH includes a control channel for a relay and a control channel for inter-cell interference control. According to an example of the present invention, ePDCCH may be allocated to a data region (i.e., data channel region) of a subframe.

The above-described ePDCCH is a new type of PDCCH being considered for a release-11 LTE system, and resource allocation of uplink control information (i.e., PUCCH) becomes necessary due to introduction of ePDCCH.

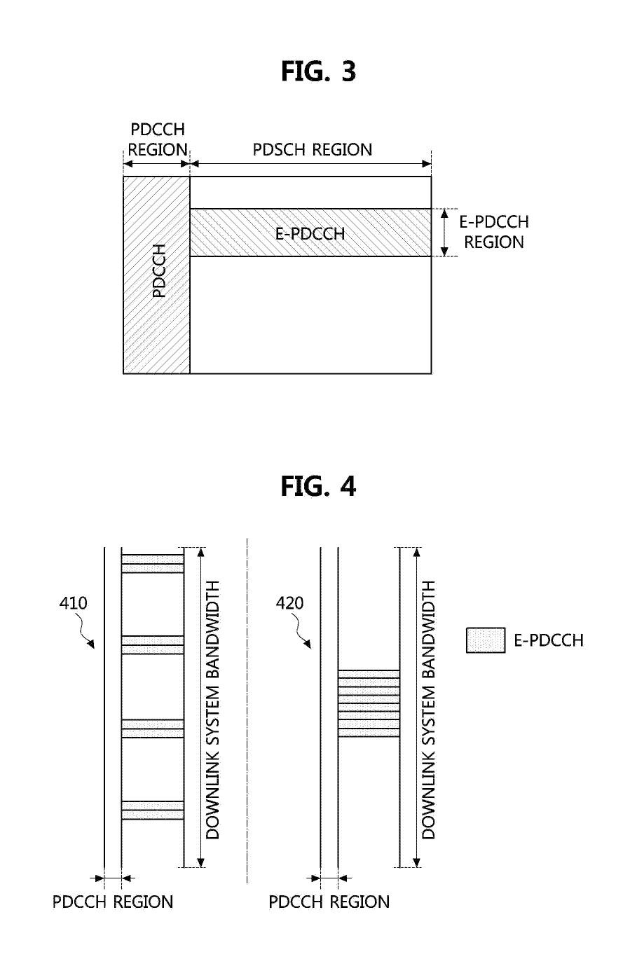

FIG. 3 illustrates an ePDCCH implementation to which an example embodiment of the present invention is applied.

A method, in which legacy PDCCHs for existing release-8/9/10 UEs are transmitted through a legacy PDCCH region and blind-decoding on only ePDCCH region (E-PDCCH region) is performed by release-11 or later UEs through upper layer signaling or system information (SI), may be considered.

According to the present example embodiments, ePDCCH for a new type carrier while using of carrier aggregation (CA), a coordinated multipoint transmission/reception (CoMP), and a downlink MIMO may be allocated in a data region (a PDSCH region).

In the present specification, allocating control information has the same meaning with allocating control channel. In other words, allocation of control channel means allocation of control information to resource elements in the present specification.

Here, control channels are allocated in units of physical resource blocks (PRB) pair corresponding to two slots (i.e., a subframe). Also, it is impossible to simultaneously allocate PDSCH and ePDCCH to a single PRB pair. In other words, PDSCH and ePDCCH cannot be multiplexed in a single PRB pair.

Meanwhile, control information or control channels of two or more terminals can be multiplexed by allocating them to a single PRB pair or by allocating them to two or more PRB pairs.

FIG. 4 illustrates a distributed transmission and a localized transmission of ePDCCH.

Referring to FIG. 4, when control information of terminals are multiplexed, a single eCCE may be allocated distributively to two or more PRB pairs, or allocated to a single PRB pair in localized manner. The former case may be referred to as a distributed transmission or a distributed type (refer to 410 of FIG. 4), and the latter case may be referred to as a localized transmission or a localized type (refer to 420 of FIG. 4).

Both the localized transmission and the distributed transmission can be supported by multiplexing control information of terminals. As compared to existing PDCCHs, the localized transmission may have better performance when a terminal moves slowly, and the distributed transmission may have better performance when a terminal moves fast.

Meanwhile, a common search space (CSS) may be supported in respect of search spaces. In this case, a common RNTI may be transmitted by using SI-RNTI, P-RNTI, RA-RNTI, TPC-PUCCH-RNTI, or TPC-PUSCH-RNTI.

According to 3GPP LTE-Advanced standardization, various discussions on carriers are going on. Among the various discussions, a carrier of a new carrier type (hereinafter, referred to as ‘NCT’) is being considered.

The NCT carrier is a component carrier in which a control region does not exist to increase payload size with reducing overhead. Also, the NCT carrier may become a secondary component carrier when a carrier aggregation (CA) technique is used.

Such the NCT may be classified into a standalone NCT (hereinafter, ‘S-NCT’) and a non-standalone NCT (hereinafter, ‘NS-NCT). Also, the NS-NCT may be classified into a synchronized NCT and an unsynchronized NCT. In the NCT, control signals such as PDCCH, PHICH, PCFICH, cell-specific reference signal (CRS), etc. may not be transmitted.

The transmission point 20 may transmit a cell-specific reference signal (CRS), a multicast/broadcast over single frequency network reference signal (MBSFN-RS), an UE-specific reference signal (DM-RS), a positioning reference signal (PRS), and a channel state information reference signal (CSI-RS) in downlink of a legacy carrier type (LCT) carrier.

The transmission point 20 may allocate primary synchronization signals (PSS) and secondary synchronization signals (SSS) to at least one specific RB in at least one subframe of a radio frame, for synchronization with a base station and cell identification of the base station. In this case, the transmission point 20 may change positions of PSS/SSS of an unsynchronized NCT in time (symbol) axis, for inter-cell interference control with LTE UEs and prevention of collisions between the PSS/SSS and DM-RS, as explained later.

Meanwhile, the transmission point 20 may not transmit a cell-specific reference signal in downlink of NCT. Instead, the transmission point 20 may transmit a tracking reference signal (TRS). The TRS may be a type of reduced CRS which is transmitted with 5 ms cycle based on antenna port 0 and release-8 sequence of conventional CRS. The transmission point 20 may also transmit a DM-RS and a CSI-RS in NCT.

Therefore, since basic demodulation can be carried out based on DM-RS due to no transmission of CRS, the positions of PSS/SSS may be changed into other OFDM symbols in order to resolve the problem of collisions between the PSS/SSS and DM-RS. In addition, PBCH transmission patterns based on DM-RS will be explained in the below description.

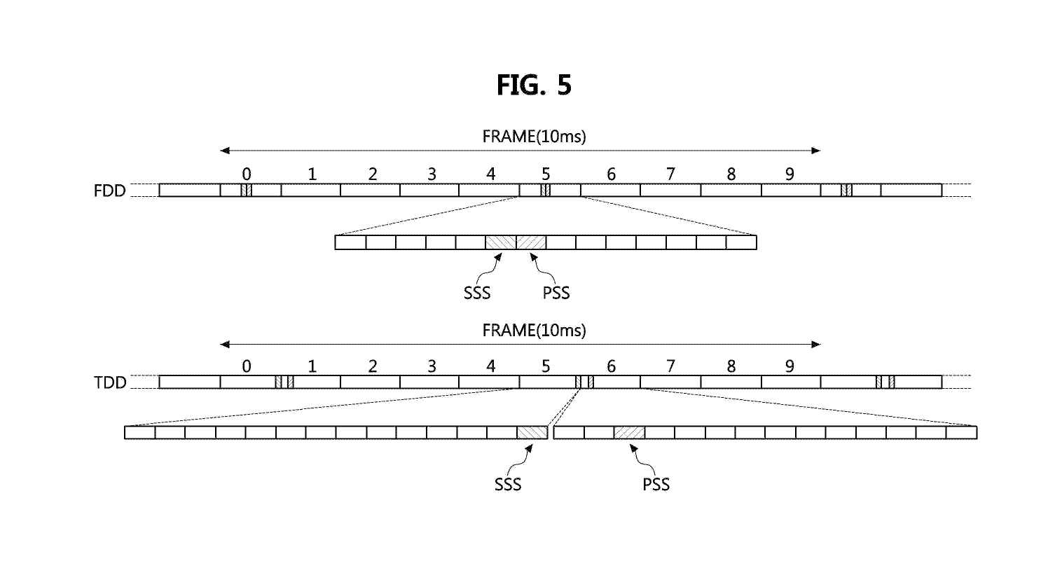

FIG. 5 illustrates positions of PSS/SSS OFDM symbols in cases of FDD and TDD.

Referring to FIG. 5, in case of FDD, the PSS is transmitted in the last symbols of the first slot of subframes 0 and 5, and the SSS is transmitted in the second symbols from the last in the same slot.

In case of TDD, the PSS is transmitted in the third symbols (i.e., DwPTS) of subframes 1 and 6, and the PSS is transmitted in the last symbols of subframe 0 and 5.

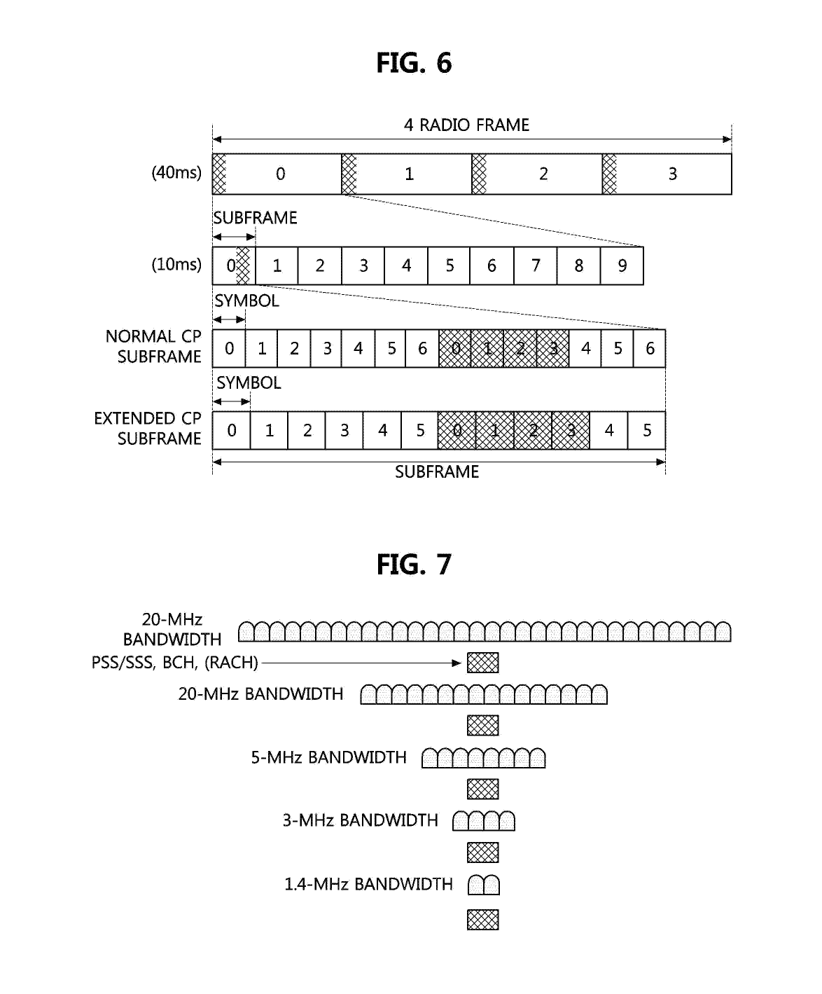

FIG. 6 illustrates positions of PBCH OFDM symbol.

Referring to FIG. 6, PBCH is mapped onto 4 subframes. PBCH is mapped onto first four symbols of the second slot of subframe 0 of each radio frame in cases of a normal CP and an extended CP.

FIG. 7 illustrates positions of subcarriers (resource elements) of PSS/SSS and PBCH for each of cases that a system bandwidth is 20 MHz, 10 MHz, 5 MHz, 3 MHz, or 1.4 MHz.

Referring to FIG. 5 and FIG. 7, the PSS is mapped onto 72 subcarriers located in a center of whole bandwidth in case of FDD. Thus, the PSS may occupy 72 resource elements of subframes 0 and 5 located in the center, excluding a DC subcarrier. The SSS may occupy 72 resource elements of subframes 0 and 5 located in the center, excluding a DC subcarrier.

In case of TDD, the PSS may occupy 72 resource elements of subframes 1 and 6, excluding a DC subcarrier. In case of TDD, identically to the case of FDD, the SSS may occupy 72 resource elements of subframes 0 and 5, excluding a DC subcarrier.

Referring to FIG. 6 and FIG. 7, PBCH is transmitted through 72 subcarriers located in the center of whole bandwidth, in the first four symbols of the second slot of subframe 0.

However, a terminal can access a cell through a random access procedure after receiving a master information block which is system information via a PBCH and decoding the system information.

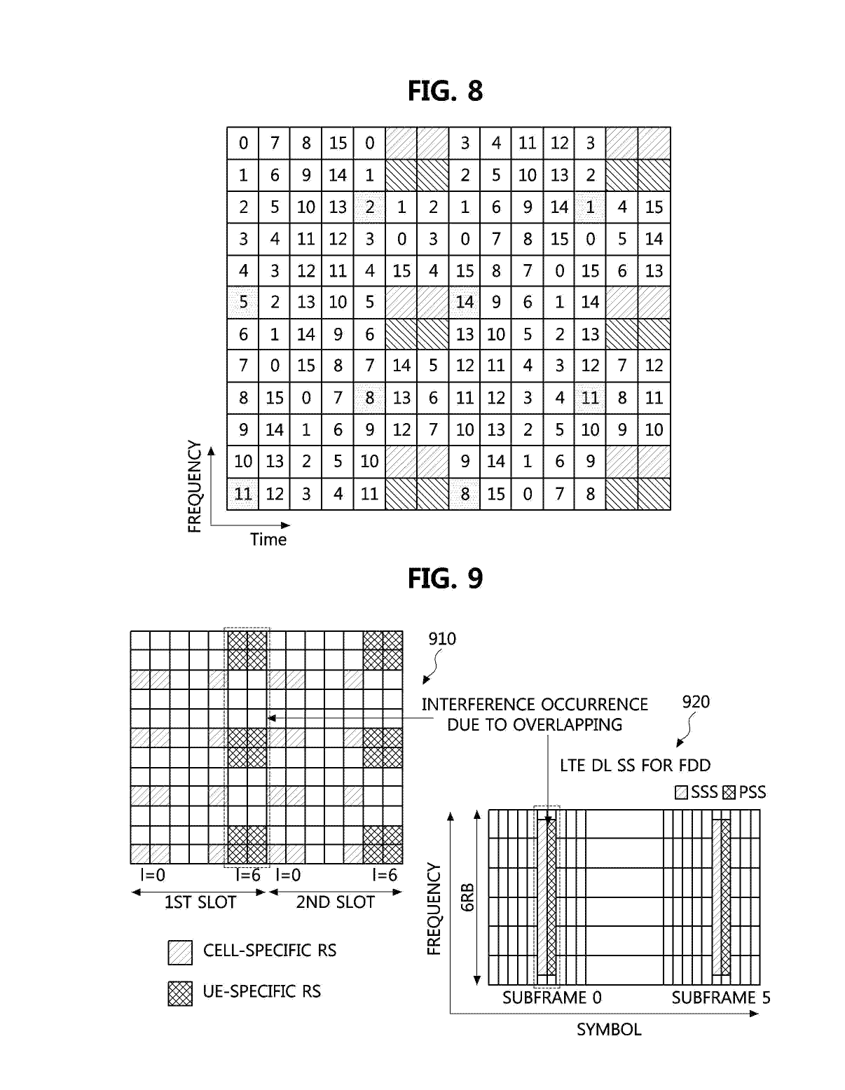

FIG. 8 illustrates symbol-based cyclic shifted eREG indexing for a PRB pair when ePDCCH is used as a NCT structure and a CRS port 0 is configured.

Also, even when other CRS ports are configured, independently from positions and numbers of CRS REs, symbol-based cyclic shifted eREG indexing for a PRB pair may be used identically to the illustration of FIG. 7.

As described above, NCT may be classified into a standalone NCT (hereinafter, ‘S-NCT’) and a non-standalone NCT (hereinafter, ‘NS-NCT). Also, the NS-NCT may be classified into a synchronized NCT and an unsynchronized NCT. When the NCT carrier is aggregated with an adjacent legacy carrier, synchronization might be provided by the legacy carrier. At least in the case of aggregating non-adjacent carriers and in case of standalone operation, the NCT carrier needs to provide a proper synchronization signal for discovery and time/frequency tracking.

1. Details of PSS/SSS

However, since CRS is not transmitted in a NCT carrier, there may be problems of receiving and decoding conventional control channels such as PBCH based on CRS. Thus, CRS may be transmitted with 5 ms cycle or transmitted through a specific frequency band. Alternatively, the above-described TRS in which both methods are combined may be transmitted.

Meanwhile, PBCH is transmitted on 6 PRBs located in the center of the second slot of subframe 0 in each radio frame.

In addition to an initial access to a system, the terminal may also perform a cell access procedure for cell reselection, handover for supporting mobility, and acquisition of synchronizations with multiple component carriers to be aggregated through a carrier aggregation (CA) technique.

A cell search procedure comprises a step of detecting PSS and SSS for acquisition of frequency synchronization and symbol synchronization. According to the procedure, frame/slot synchronizations of a cell may be acquired and a cell ID may be determined. On the other hand, other signals in addition to or instead of the PSS/SSS may be used for the cell search procedure in a NCT carrier.

After acquisition of the cell synchronization and determination of the cell ID, a step of identifying whether the corresponding cell is a NCT carrier or a LCT carrier may be performed, and the TRS may be identified. According to this, RRM measurements or demodulation of PBCH may be performed. As described above, in case that CRS is not transmitted, demodulation of PBCH may be carried out based on DM-RS. The PHCH includes system information.

Thus, detection of the PSS/SSS and the PBCH may become a basis of the cell access procedure according to the cell search.

In order to evade collisions between PSS/SSS and DM-RS, positions of the PSS/SSS may be moved in time axis or DM-RS puncturing may be performed.

Meanwhile, if the DM-RS puncturing is performed, in case of PBCH where a channel is estimated based on DM-RS, channel estimation errors may occur according to the puncturing. Especially, for terminals moving with high speed, the above channel estimation errors may become significant. As a method to resolve the above channel estimation errors, a method of changing PBCH channel mapping positions in time axis may be used.

In order to evade collisions with DM-RS when PSS/SSS exist in a NCT carrier, examples of movement to other OFDM symbol positions, DM-RS puncturing, and use of PBCH transmission patterns according to DM-RS patterns different from the conventional patterns are proposed. Specifically, as a method of moving PSS/SSS to evade collisions between PSS/SSS and DM-RS, there are a method of maintaining relative positions of PSS/SSS and a method of changing relative positions of PSS/SSS. Meanwhile, in addition to the method of DM-RS puncturing, there may be a method of prohibiting PDSCH transmission through PRBs having PSS/SSS (e.g., 6 PRBs located in a center frequency). In order to provide enhanced performance of PDSCH demodulation when legacy control regions do not exist, DM-RS patterns in a NCT carrier (e.g., for all subframes) may change.

Also, in order to evade collisions between PSS/SSS and DM-RS when the PSS/SSS exist in a NCT carrier, in addition to the above-described methods of movement to other OFDM symbol positions, DM-RS puncturing, and use of PBCH transmission patterns according to DM-RS patterns different from the conventional patterns, the present invention provides a method of evading collisions between PSS/SSS and DM-RS while maintaining positions of PSS/SSS and DM-RS to be identical to the conventional positions.

FIG. 9 illustrates collisions between PSS/SSS and DM-RS.

As shown in FIG. 9, problems of interferences/collisions between PSS/SSS and DM-RS according to coincidence of their positions may occur. That is, the DM-RS illustrated in 910 of FIG. 9 and the PSS/SSS of subframes 0 and 5 illustrated in 920 of FIG. 9 are mapped onto the same symbols in time axis. On the other, methods of evading such the problems by changing positions of PSS/SSS or DM-RS are being proposed. Of course, instead of changing DM-RS positions, a method of transmitting signals which can be separated may be considered as another method.

Therefore, an example embodiment of the present invention provides a method of evading collisions between PSS/SSS and DM-RS by code-division-multiplexing PSS/SSS and DM-RS without changing positions of PSS/SSS and DM-RS in a NCT carrier.

As explained later in detail, when DM-RS is mapped onto a complex demodulation symbol for supporting MU-MIMO, the DM-RS is multiplexed by using an orthogonal sequence.

For an antenna port pε{7,8, . . . ,υ+6} (identically applied also to an antenna port 5), DM-RS sequence (r(m)) related to PDSCH may be defined as the following equation 1.

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = \{ \begin{matrix}0 , 1 , … , 12 {N}_{RB}^{max , DL} - 1 & normal cyclic prefix \\ 0 , 1 , … , 16 {N}_{RB}^{max , DL} - 1 & extended cyclic prefix\end{matrix} \qquad [ Equation 1 ]$$

In the equation 1, N_{RB}^{max,DL} is a maximum downlink bandwidth in units of resource blocks. For example, it may be 110. The pseudo-random sequence c(i) may be initialized as the following equation 2.

$${c}_{init} = ( ⌊ {n}_{s} / 2 ⌋ + 1 ) \cdot ( 2 {n}_{ID}^{( {n}_{SCID} )} + 1 ) \cdot {2}^{16} + {n}_{SCID} \qquad [ Equation 2 ]$$

In the equation 2, ns, a slot number, may be one of 0 to 19. Also, n_{SCID} is a scrambling identity having a value of 0 or 1. A value of n_{ID}⁽ⁿ^{_{SCID}}⁾ becomes a cell ID (n_{ID}^{(cell)}) when a value of n_{ID}^{(DMRS,i)} is not provided by a higher layer or DCI format 1A is used. In other cases, A value of n_{ID}⁽ⁿ^{_{SCID}}⁾ becomes n_{ID}^{(DMRS,i)}. According to the equations 1 and 2, DM-RSs may have pseudo orthogonality when n_{SCID} values of them are different from each other.

For an antenna port (identically applied also to an antenna port 5), a part of DM-RS (a_{k,l}^{(p)}r(m)) may be mapped onto demodulation complex symbols of the following equation 3 in n_{PRB} PRB having frequency domain index pε{7,8, . . . ,υ+6} in case of a normal CP subframe.

a_{k,l}^{(p)}=wₚ(l′)·r(3·l′·N_{RB}^{max,DL}+3·n_{PRB}+m′) [Equation 3]

A symbol number (l) and subcarrier number (k) of resource elements onto which DM-RS sequence (r(m)) related to PDSCH is mapped may be determined according to the following equation 4.

$$[ Equation 4 ]$$

$${w}_{p} ( i ) = \{ \begin{matrix}{\overline{w}}_{p} ( i ) & ( {m}^{′} + {n}_{PRB} ) mod 2 = 0 \\ {\overline{w}}_{p} ( 3 - i ) & ( {m}^{′} + {n}_{PRB} ) mod 2 = 1\end{matrix} \\ k = 5 {m}^{′} + {N}_{sc}^{RB} {n}_{PRB} + {k}^{′} \\ {k}^{′} = \{ \begin{matrix}1 & p ∈ \{ 7 , 8 , 11 , 13 \} \\ 0 & p ∈ \{ 9 , 10 , 12 , 14 \}\end{matrix} \\ l = \{ \begin{matrix}{l}^{′} mod 2 + 2 & \begin{matrix}if in a special sub frame with configu \text{-} \\ ration 3 , 4 , 8 or 9 ( see Table 4.2 \text{-} 1 )\end{matrix} \\ {l}^{′} mod 2 + 2 + 3 ⌊ {l}^{′} / 2 ⌋ & \begin{matrix}if in a special su bframe with configu \text{-} \\ ration 1 , 2 , 6 , or 7 ( see Table 4.2 \text{-} 1 )\end{matrix} \\ {l}^{′} mod 2 + 5 & if not in a special subframe\end{matrix} \\ {l}^{′} = \{ \begin{matrix}0 , 1 , 2 , 3 & \begin{matrix}if {n}_{s} mod 2 = 0 and in a special subframe with \\ configuration 1 , 2 , 6 , or 7 ( see Table 4.2 \text{-} 1 )\end{matrix} \\ 0 , 1 & \begin{matrix}if {n}_{s} mod 2 = 0 and not in special subframe with \\ configuration 1 , 2 , 6 , or 7 ( see Table 4.2 \text{-} 1 )\end{matrix} \\ 2 , 3 & \begin{matrix}if {n}_{s} mod 2 = 1 and not in special subframe with \\ configuration 1 , 2 , 6 , or 7 ( see Table 4.2 \text{-} 1 )\end{matrix}\end{matrix} \\ {m}^{′} = 0 , 1 , 2$$

In the equation 4, N_{SC}^{RB} means the size of resource block in frequency domain, being represented as the number of subcarriers, n_{PRB} mean a physical resource block number, and nₛ means a slot number. Here, orthogonal sequences w̅ₚ(i) may be given as the following table 1.

TABLE 1

| Antenna port p | [ w̅ₚ(0) w̅ₚ(1) w̅ₚ(2) w̅ₚ(3)] |
|---|---|
| 7 | [+1 +1 +1 +1] |
| 8 | [+1 −1 +1 −1] |
| 9 | [+1 +1 +1 +1] |
| 10 | [+1 −1 +1 −1] |
| 11 | [+1 +1 −1 −1] |
| 12 | [−1 −1 +1 +1] |
| 13 | [+1 −1 −1 +1] |
| 14 | [−1 +1 +1 −1] |

Meanwhile, a part of DM-RS (a_{k,l}^{(p)}r(m)) is mapped on complex demodulation symbols of the following equation 5 in an extended CP subframe.

a_{k,l}^{(p)}=wₚ(l′ mod 2)·r(4·l′·N_{RB}^{max,DL}+4·n_{PRB}+m′) [Equation 5]

A symbol number (l) and subcarrier number (k) of resource elements onto which a DM-RS sequence (r(m)) related to PDSCH is mapped may be determined according to the following equation 6.

$$[ Equation 6 ]$$

$${w}_{p} ( i ) = \{ \begin{matrix}{\overline{w}}_{p} ( i ) & {m}^{′} mod 2 = 0 \\ {\overline{w}}_{p} ( 1 - i ) & {m}^{′} mod 2 = 1\end{matrix} \\ k = 3 {m}^{′} + {N}_{sc}^{RB} {n}_{PRB} + {k}^{′} \\ {k}^{′} = \{ \begin{matrix}1 & if {n}_{s} mod 2 = 0 and p ∈ \{ 7 , 8 \} \\ 2 & if {n}_{s} mod 2 = 1 and p ∈ \{ 7 , 8 \}\end{matrix} \\ l = {l}^{′} mod 2 + 4 \\ {l}^{′} = \{ \begin{matrix}0 , 1 & \begin{matrix}if {n}_{s} mod 2 = 0 and in a special subframe with \\ configuration 1 , 2 , 3 , 5 or 6 ( see Table 4.2 \text{-} 1 )\end{matrix} \\ 0 , 1 & if {n}_{s} mod 2 = 0 and not in a special subframe \\ 2 , 3 & if {n}_{s} mod 2 = 1 and not in a special subframe\end{matrix} \\ {m}^{′} = 0 , 1 , 2 , 3$$

Here, orthogonal sequences may be given as the following table 2.

TABLE 2

| Antenna port p | [ w̅ₚ(0) w̅ₚ(1)] |
|---|---|
| 7 | [+1 +1] |
| 8 | [−1 +1] |

The present invention provides a method of evading collisions between PSS/SSS and DM-RS by code-division-multiplexing PSS/SSS and DM-RS without changing positions of PSS/SSS and DM-RS in a NCT carrier. For example, when collisions between PSS/SSS and DM-RS may occur, orthogonal sequence may be used for DM-RS when the DM-RS is mapped on complex demodulation symbols. Also, the present invention provides a method of changing positions of DM-RS overlapped with PSS/SSS in a NCT carrier.

First, the code division multiplexing will be explained as follows.

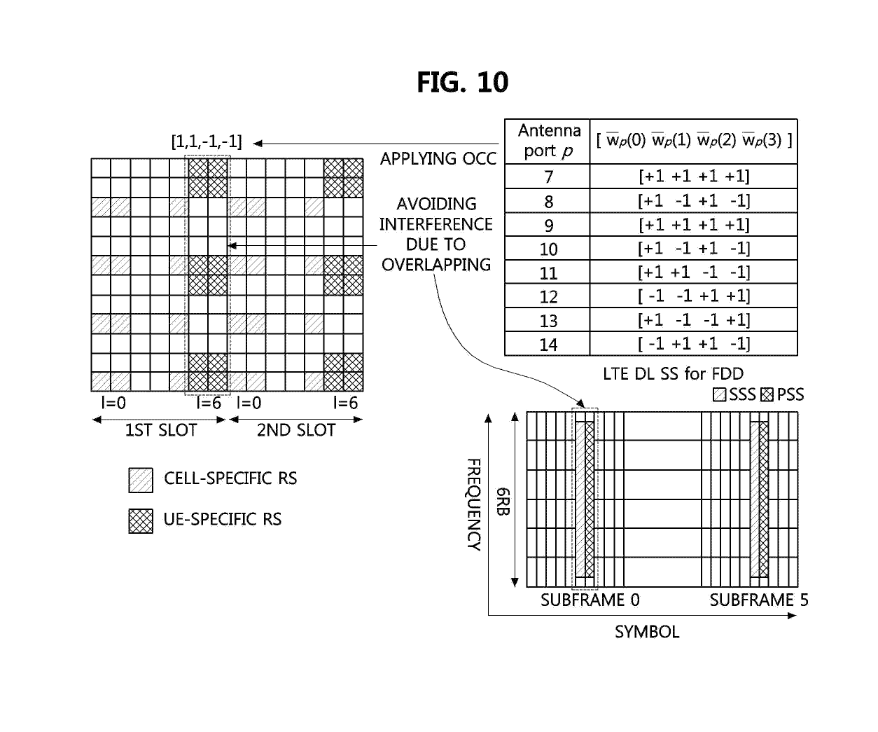

FIG. 10 illustrates a code division multiplexing of PSS/SSS and DM-RS according to an example embodiment of the present invention. In FIG. 10, similarly to the case of FIG. 9, interferences are canceled through orthogonality between PSS/SSS and DM-RS by applying an orthogonal cover code (OCC) of the table 1 to DM-RS when PSS/SSS and DM-RS are mapped onto the same symbols. Therefore, even when DM-RS and PSS/SSS are mapped onto the same symbols, a terminal can separate them.

As compared to the case of FIG. 9, according to the use of code division multiplexing, interferences between DM-RS and PSS/SSS positioned in the same symbols can be canceled.

Specifically, a_{k,l}^{(p)} of DM-RS may be mapped onto complex demodulation symbols of the following equation 7 in a normal CP subframe.

a_{k,l}^{(p)}=w(l)·wₚ(l′)·r(3·l′·N_{RB}^{max,DL}+3·n_{PRB}+m′) [Equation 7]

In the equation 7, W(l) means w(x,y) where x means a position of a corresponding slot in a corresponding subframe and y means a position of a corresponding subcarrier.

Thus, since an additional orthogonal sequence (e.g., [1,1,−1,−1]) is multiplied to complex demodulation symbols when w(x,y) is w(5,0), w(6,0), w(5,1), w(6,1), w(5,5), w(6,5), w(5,6), w(6,6), w(5,10), w(6,10), w(5,11), or w(6,11), DM-RS and PSS/SSS can be code-division-multiplexed.

The transmission point can transmit the orthogonal code used for code division multiplexing of DM-RS and PSS/SSS implicitly or explicitly (via RRC signaling, system information, etc.). However, instead of the indication, a terminal may blind-decode candidate orthogonal codes sequentially. In other words, in case that DM-RS and PSS/SSS are code-division-multiplexed by using 8 orthogonal codes illustrated in FIG. 10, a terminal can perform blind-decoding by sequentially using 8 orthogonal codes. The code division multiplexing of FIG. 10 may be applied to a part of all DM-RSs, and also applied to DM-RSs positions of which are moved.

Also, a terminal may transmit information on a manner of the sequential blind-decoding for DM-RS located in same positions with PSS/SSS by using 8 orthogonal codes and orthogonal codes to be used.

The above method of sequential blind decoding is a method in which a terminal sequentially applies 8 orthogonal codes in the table 1 and identifies whether DM-RS is properly decoded or not so that time overhead may occur to the terminal. An example embodiment of antenna ports and orthogonal codes is shown in the table 1. Information on orthogonal code may be included in a RRC message when the RRC message is used for explicit indication.

As an example embodiment of the explicit indication, information indication an orthogonal code to be used may be included in an RRC message. Or, information on only some orthogonal codes among 8 orthogonal codes may be transmitted as included in the RRC message, and the terminal may perform blind-decoding by using the only some orthogonal codes. This can be explained as indication of an orthogonal code group. That is, only some orthogonal codes among 8 orthogonal codes may be formed as an orthogonal code group, and information on the orthogonal code group may be transmitted to the terminal as included in the RRC message. Thus, the number of blind-decoding performed by the terminal may be reduced. For example, if a base station transmits information on only orthogonal codes of the following table 3 among 8 orthogonal codes of the table via RRC signaling, the terminal may perform blind decoding by using only orthogonal codes of the table 3. In this case, the number of blind decoding may be reduced to at most 4. Then, the terminal may perform blind decoding by using the table 3 until new information on orthogonal codes is received via RRC signaling.

TABLE 3

| Antenna port p | [ w̅ₚ(0) w̅ₚ(1) w̅ₚ(2) w̅ₚ(3)] |
|---|---|
| 7 | [+1 +1 +1 +1] |
| 8 | [+1 −1 +1 −1] |
| 9 | [+1 +1 +1 +1] |
| 10 | [+1 −1 +1 −1] |

As compared to the table 1, the table 3 includes only some of orthogonal codes. Information on an orthogonal code group including orthogonal codes shown in the tables 1 or 3 may be transmitted to the terminal, and the terminal may perform blind decoding based on the information. Also, information indicating an orthogonal code may be included in an RRC message and transmitted to the terminal, and the terminal may identify DM-RS by using the orthogonal code.

In order to extract an orthogonal code group from all orthogonal codes (e.g., extracting the table 3 from the table 1), a base station may perform selection of orthogonal codes which can be allocated to a corresponding terminal during a predetermined period. For the selection, the base station may select DM-RS proper for the corresponding terminal. Also, the base station may perform the selection by also considering orthogonal codes to be applied to PSS/SSS positions of which are overlapped with DM-RS. The manner of selecting a group from orthogonal codes in the table 1 may vary according to a promise between a base station and a terminal or a situation of the terminal.

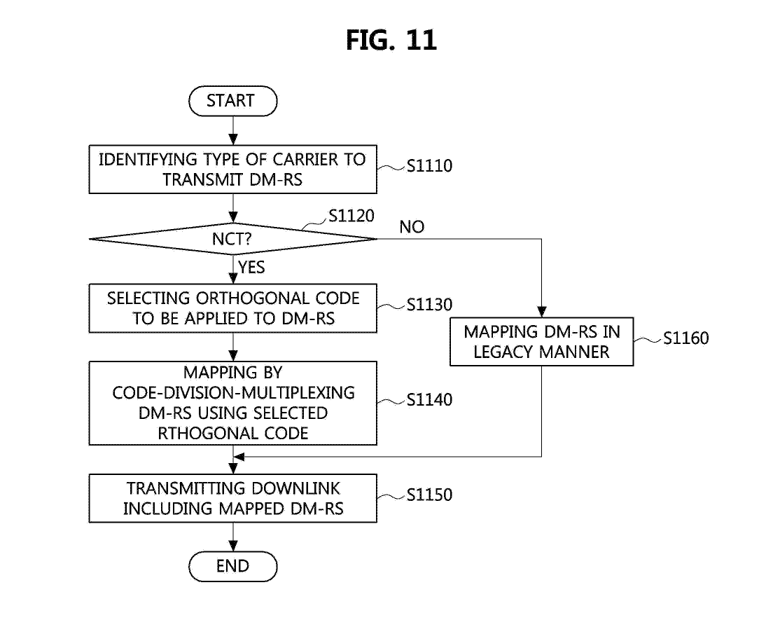

FIG. 11 illustrates an operation procedure of a base station according to an example embodiment of the present invention.

The base station in FIG. 11 proposes a procedure for transmitting a demodulation reference signal in a NTC carrier. The base station may identity the type of carrier through which the demodulation reference signal is transmitted (S1110). If the carrier is a NCT carrier (S1120), the base station may select an orthogonal code to be applied to the demodulation reference signal (S1130), performing code-division-multiplexing on the demodulation reference signal by using the selected orthogonal code, and mapping the demodulation reference signal (S1140). This procedure means a procedure in which code division multiplexing is carried out on the demodulation reference signal to be mapped on symbols overlapped with PSS/SSS located in a downlink subframe of the carrier by using the orthogonal code. The base station transmits the downlink subframe including the mapped demodulation reference signal (S1150). That is, the base station transmits the downlink subframe including the demodulation reference signal to which the code division multiplexing is applied. On the contrary, if the carrier is not a NCT carrier, the base station may map a legacy demodulation reference signal (S1160).

If the procedure of FIG. 11 is explained in further detail, in a case that the base station transmits information indicating an orthogonal code, the base station may transmit the information indicating the orthogonal code as included in an RRC message. Also, as explained in the exampled embodiment for the table 3, the base station may transmit information on an orthogonal code group. In other words, in case that information on an orthogonal code group including two or more orthogonal codes is transmitted as included in the RRC message, the terminal may perform blind-decoding by using only orthogonal codes included in the orthogonal code group.

Here, the orthogonal code may be one of orthogonal sequences of the table 1.

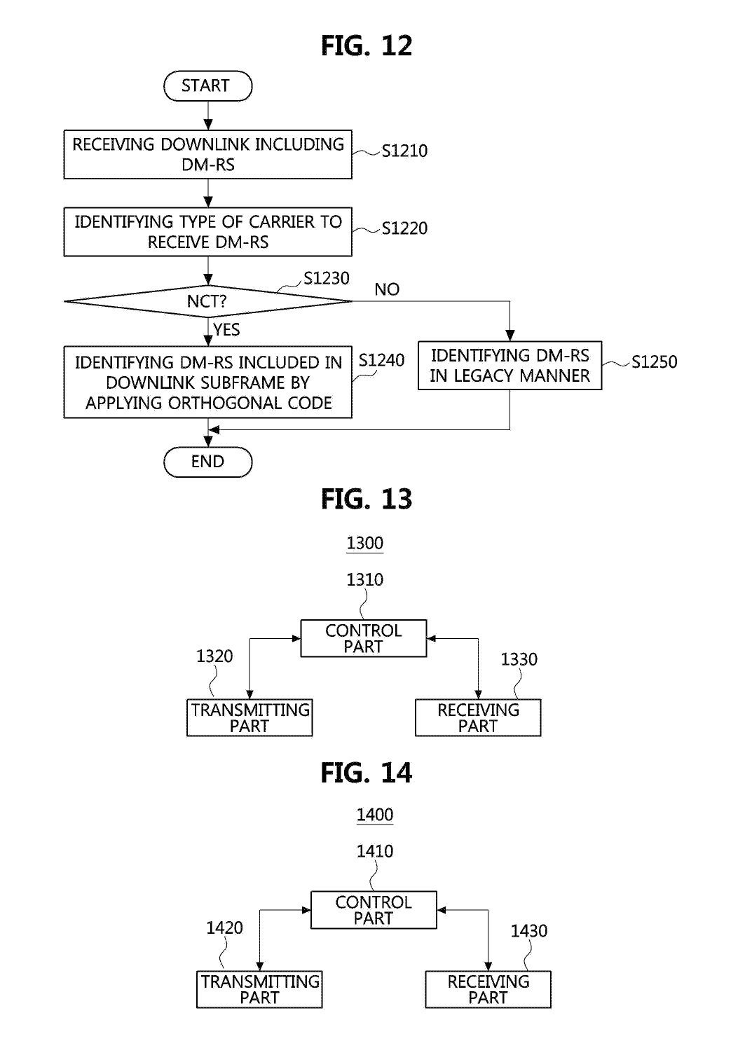

FIG. 12 is a diagram showing an operation procedure of a terminal according to an example embodiment of the present invention. The terminal of FIG. 12 proposes a procedure for receiving a demodulation reference signal in a NCT carrier.

The terminal may receive a downlink subframe including a demodulation reference signal (S1210). Then, the terminal may identify the type of the carrier through which the demodulation reference signal is received (S1220). If the carrier is a NCT carrier (S1230), the terminal may identify the demodulation reference signal included in the downlink subframe by applying an orthogonal code (S1240). Here, the demodulation reference signal is mapped onto symbols overlapped with PSS/SSS located in the downlink subframe, and the PSS/SSS and the DM-RS are code-division-multiplexed.

The step S1240 may be explained in further detail as follows.

First, in a case that a base station transmits information indicating an orthogonal code, the terminal may use the indicated orthogonal code. That is, the terminal may receive an RRC message including the information indicating the orthogonal code, and identify the demodulation reference signal by using the orthogonal code indicated by the information. If the orthogonal code is not indicated or there is not the information indicating the orthogonal code, the terminal performs blind decoding. Therefore, the step S1240 may include a procedure of blind decoding in which the terminal performs blind decoding on the demodulation reference signal by using a plurality of orthogonal codes. In case that the base station indicates an orthogonal code group as shown in the table 3, the number of blind decoding may be reduced. That is, if the terminal receives an RRC message including information on an orthogonal code group including orthogonal codes on which blind decoding is performed, the terminal may perform blind decoding by using only orthogonal codes included in the orthogonal code group, and identify the demodulation reference signal. Here, the orthogonal code may be one of orthogonal sequences of the table 1.

FIG. 13 is a diagram showing a configuration of a base station according to an example embodiment of the present invention.

Referring to FIG. 13, a base station 1300 according to an example embodiment of the present invention may comprise a control part 1310, a transmitting part 1320, and a receiving part 1330.

The control part 1310 may control overall operations of the base station according to the above-described structures and operations for a NCT carrier required to perform the present invention.

The transmitting part 1320 and the receiving part 1330 are used for transmitting and receiving signals, messages, and data required for performing the present invention with a terminal.

In further detail, the base station of FIG. 13 transmits a demodulation reference signal having orthogonality in a NCT carrier explained through FIG. 10 and FIG. 11. The receiving part 1330 may receive signals from the terminal, and the control part 1310 may perform code division multiplexing on the demodulation reference signal to be mapped onto symbols overlapped with PSS/SSS located in a downlink subframe of the carrier by using an orthogonal code. Also, the transmitting part 1320 may transmit the downlink subframe including the demodulation reference signal to which the code division multiplexing is applied.

FIG. 14 is a diagram showing a configuration of user equipment according to an example embodiment of the present invention.

Referring to FIG. 14, the user equipment (i.e., the terminal) 1400 according to an example embodiment of the present invention may comprise a control part 1410, a transmitting part 1420, and a receiving part 1430.

The receiving part 1430 may receive downlink control information, data, and messages from a base station through corresponding channels.

Also, the control part 1410 may control overall operations of the terminal according to the above-described structures and operations for a NCT carrier required to perform the present invention.

The transmitting part 1420 may transmit downlink control information, data, and message to the base station through corresponding channels.

In further detail, the terminal of FIG. 14 receives a demodulation reference signal having orthogonality in a NCT carrier explained through FIG. 10 and FIG. 12, and identifies the demodulation reference signal. The receiving part 1430 receives a downlink subframe including the demodulation reference signal, and the control part 1410 identifies the demodulation reference signal positioned in the downlink subframe of the carrier by using an orthogonal code. In this case, the demodulation reference signal is mapped onto symbols overlapped with PSS/SSS located in the downlink subframe of the carrier, and the PSS/SSS and the demodulation reference signal are code-division-multiplexed. The transmitting part 1420 transmits signals to the base station.

In the above-described example embodiment according to the present invention, interferences between PSS/SSS and DM-RS can be resolved by performing code-division multiplexing based on orthogonal codes when DM-RS is overlapped with PSS/SSS. That is, through implementation of the present invention, collisions between PSS/SSS and DM-RS can be evaded while maintaining positions of PSS/SSS and DM-RS to be conventional positions.

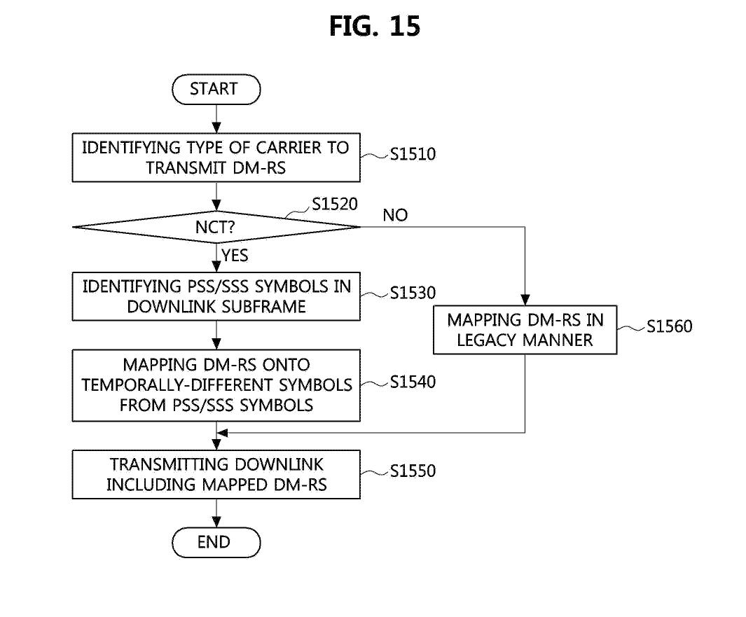

Hereinafter, in order to evade collisions with DM-RS when PSS/SSS exists in a NCT carrier, a procedure of changing mapping positions of DM-RS will be explained. FIG. 15 is a diagram showing a procedure of transmitting a demodulation reference signal in a base station according to another example embodiment of the present invention.

The base station may identity the type of carrier through which the demodulation reference signal is transmitted (S1510). If the carrier is a NCT carrier (S1520, the base station may identify symbols on which PSS/SSS is positioned in a downlink subframe of the carrier (S1530). This step is for mapping the demodulation reference signal onto symbols different in time axis from symbols of PS S/SSS located in the downlink subframe of the carrier. The base station maps the demodulation reference signal onto symbols different from the identified symbols on which PSS/SSS is positioned (S1540). Then, the base station transmits the downlink subframe including the mapped demodulation reference signal (S1550). On the contrary, if the carrier is not a NCT carrier, the base station may map a legacy demodulation reference signal (S1560).

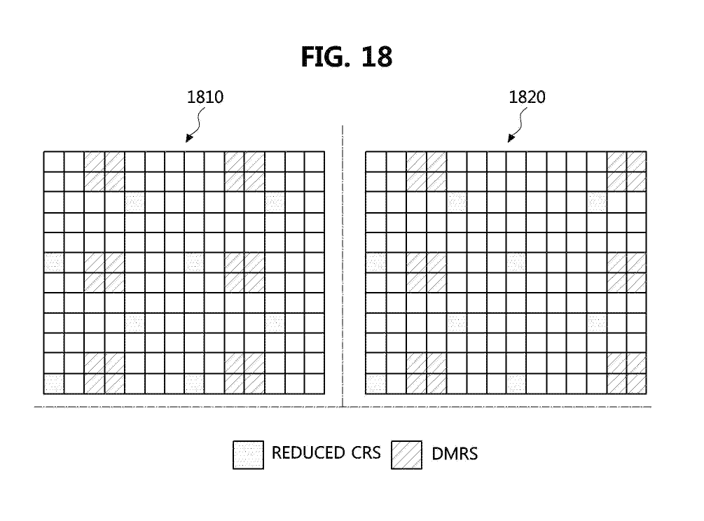

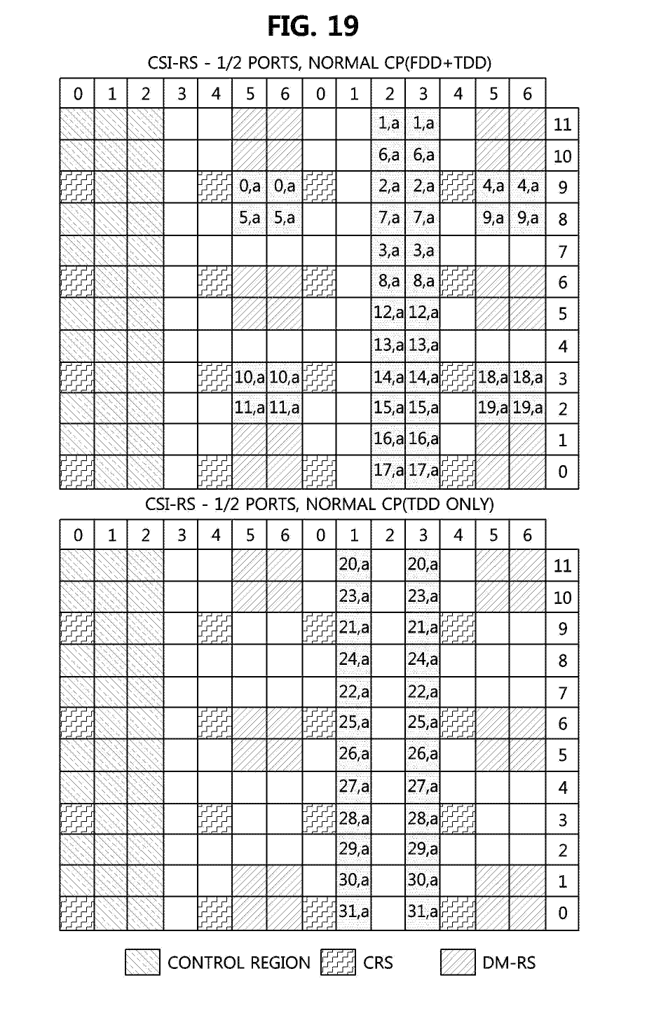

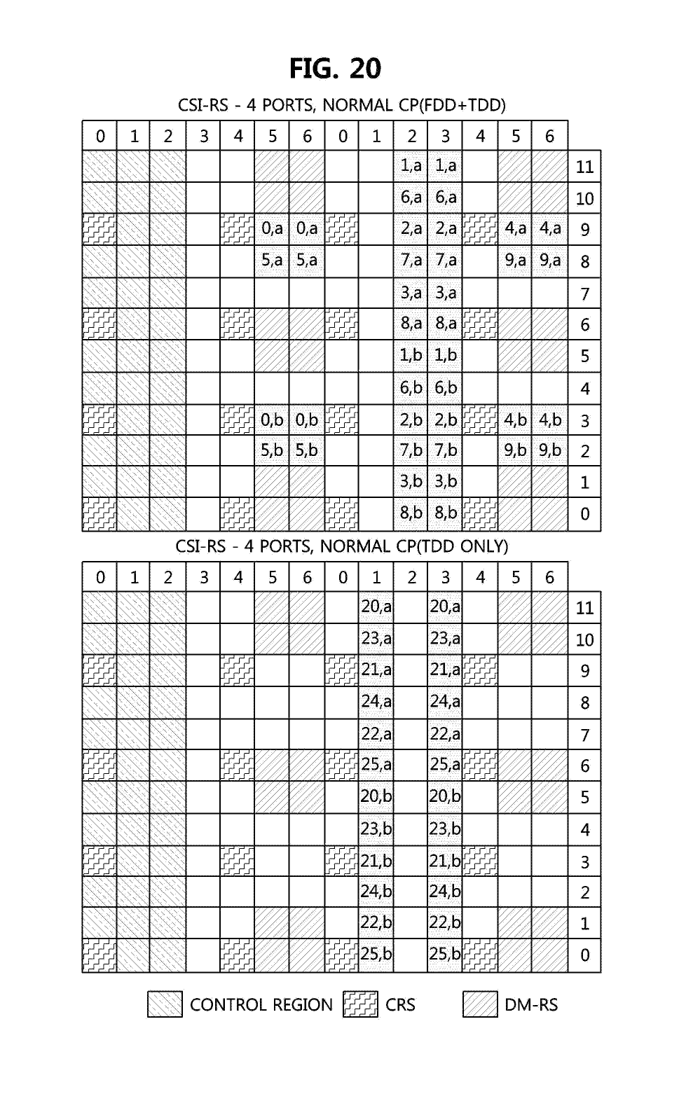

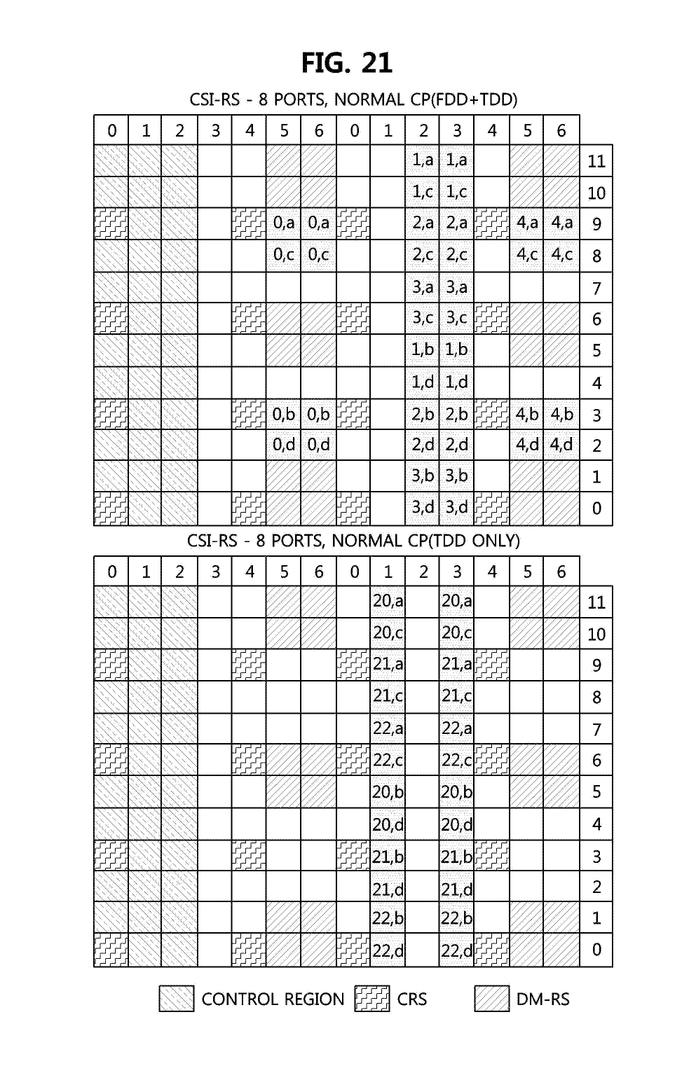

In the steps S1530 and S1540, the symbols different temporally from the PSS/SSS may be selected variously according to an implementation manner. For example, the downlink subframe comprises two slots, and the demodulation reference signal is positioned in third and fourth symbols of the respective slots. Alternatively, the demodulation reference signal may be positioned in third and fourth symbols at the first slot, and positioned in sixth and seventh symbols at the second slot. This case will be explained in detail by referring to FIG. 18. Meanwhile, the position change of DM-RS may cause overlapping with CSI-RS. This situation is illustrated FIGS. 19 to 21. In this case, the base station may re-schedule the CSI-RS. The re-scheduled CSI-RS may be transmitted in different positions.

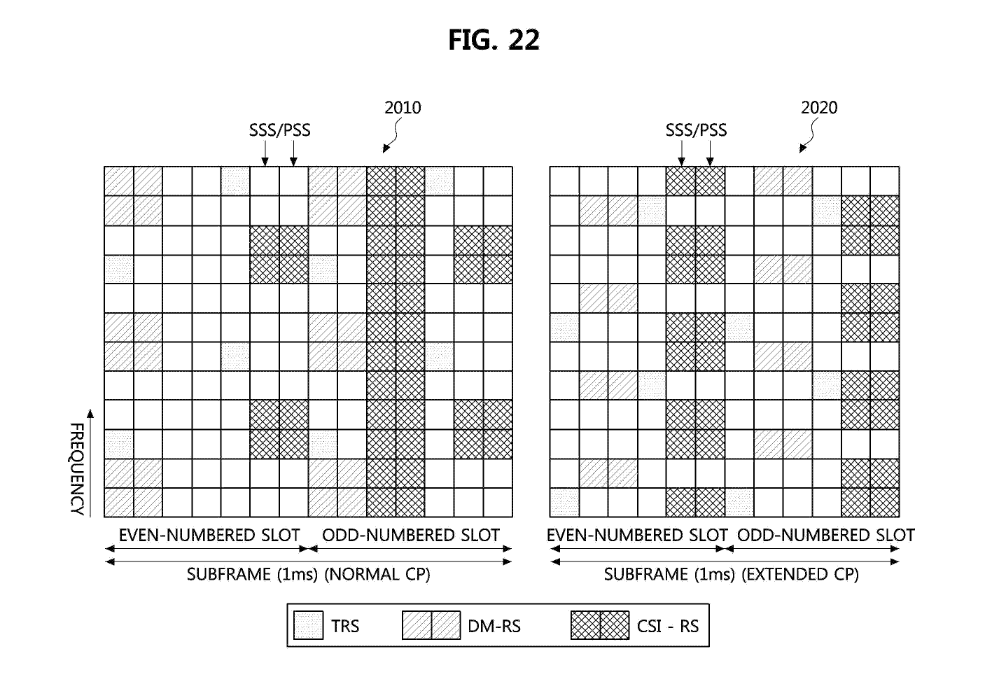

For the steps S1530 and S1540, in case of FDD, the selection of symbols different temporally from PSS/SSS may be performed as follows. If a subframe comprising two slots is a normal CP subframe, the demodulation reference signal may be positioned in first and second symbols of the respective slots. Also, if the subframe comprising two slots is an extended CP subframe, the demodulation reference signal may be positioned in second and third symbols of the respective slots. This will be explained in detail by referring to FIG. 22.

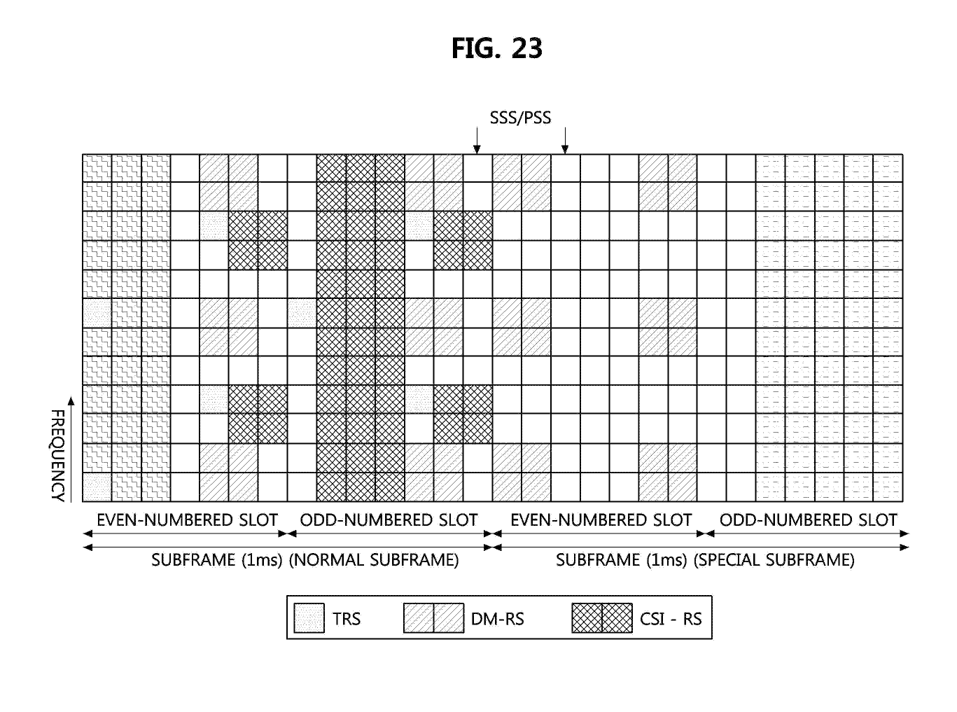

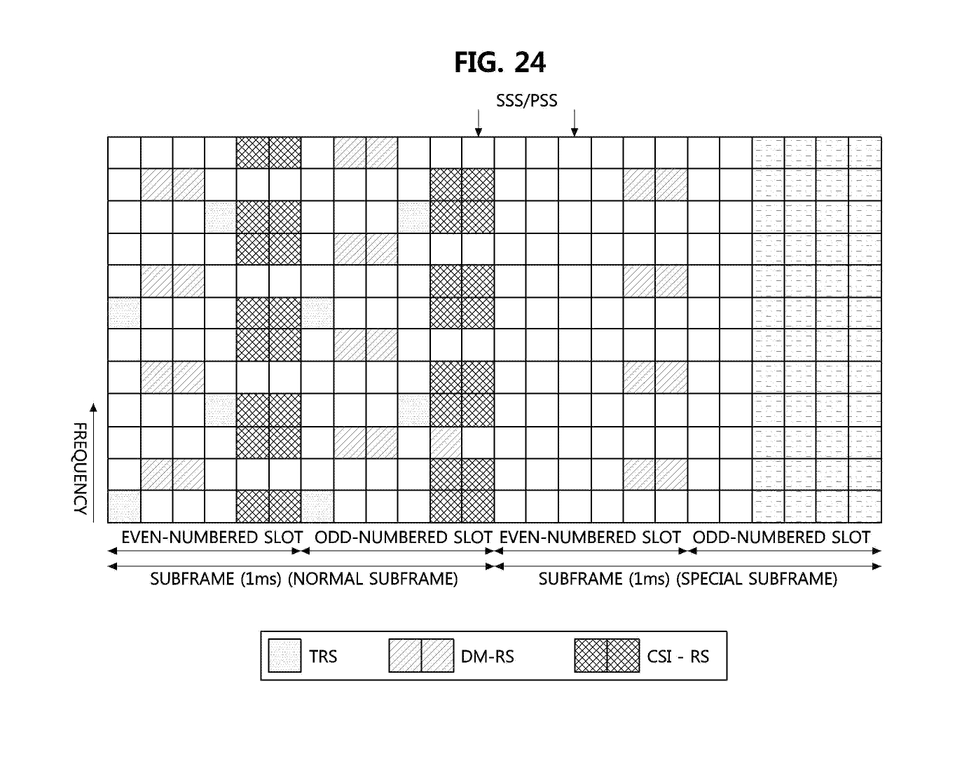

Also, in case of TDD, if the subframe comprising two slots is a normal CP subframe, the demodulation reference signal may be positioned in a position other than the last symbol of the second slot. Also, if the subframe is a special subframe, the demodulation reference signal may be mapped onto positions other than the third symbol of the first slot. FIG. 23 illustrates the case of normal CP, and FIG. 24 illustrates the case of extended CP.

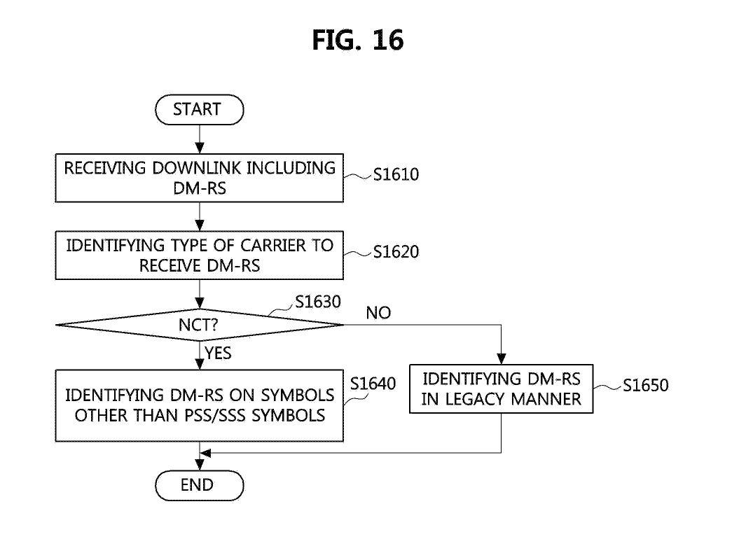

FIG. 16 is a diagram showing a procedure in which a terminal according to another example embodiment of the present invention receives a demodulation reference signal.

The terminal may receive a downlink subframe including a demodulation reference signal (S1610). Then, the terminal may identify the type of the carrier through which the demodulation reference signal is received (S1620). If the carrier is a NCT carrier (S1630), the terminal may identify the demodulation reference signal in symbols onto which PSS/SSS is not mapped in the downlink subframe (S1640). In other words, the terminal may identify the demodulation reference signal mapped on symbols which are temporally different from PSS/SSS positioned in the downlink subframe of the carrier.

On the contrary, if the carrier is not a NCT carrier, the terminal may identify the demodulation reference signal in the legacy manner (S1650).

In the step S1640, the symbols different temporally from PSS/SSS may be selected variously according to an implementation manner. For example, the downlink subframe comprises two slots, and the demodulation reference signal is positioned in third and fourth symbols of the respective slots. Alternatively, the demodulation reference signal may be positioned in third and fourth symbols at the first slot, and positioned in sixth and seventh symbols at the second slot. This case will be explained in detail by referring to FIG. 18. Meanwhile, the position change of DM-RS may cause overlapping with CSI-RS. This situation is illustrated FIGS. 19 to 21. In this case, the base station may re-schedule the CSI-RS, and the terminal may identify the re-scheduled CSI-RS.

For the step S1640, in case of FDD, the selection of symbols different temporally from PSS/SSS may be performed as follows. If a subframe comprising two slots is a normal CP subframe, the demodulation reference signal may be positioned in first and second symbols of the respective slots. Also, if the subframe comprising two slots is an extended CP subframe, the demodulation reference signal may be positioned in second and third symbols of the respective slots. The terminal may identify DM-RS in the above positions. This will be explained in detail by referring to FIG. 22.

Also, in case of TDD, if the subframe comprising two slots is a normal CP subframe, the demodulation reference signal may be mapped onto positions other than the last symbol of the second slot. Also, if the subframe is a special subframe, the demodulation reference signal may be mapped onto positions other than the third symbol of the first slot. The terminal may identify DM-RS in the above positions. FIG. 23 illustrates the case of normal CP, and FIG. 24 illustrates the case of extended CP.

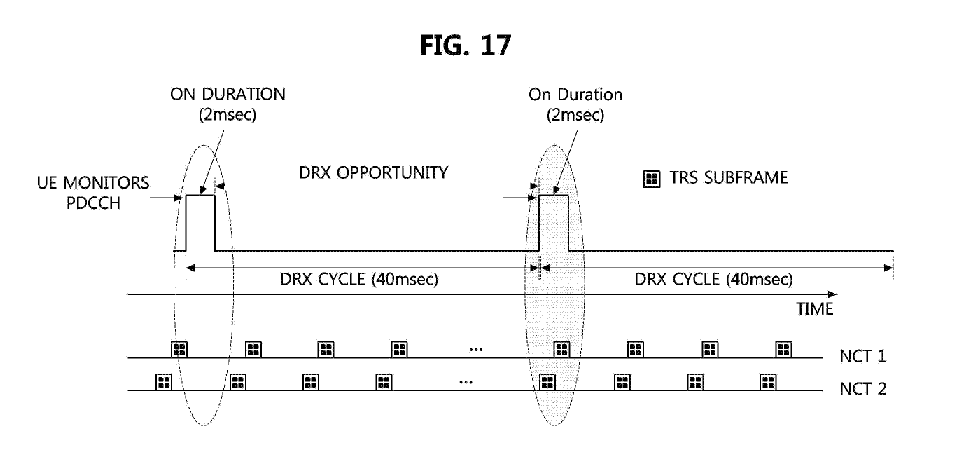

FIG. 17 is a diagram illustrating intra-frequency RRM measurement having 2 ms on-duration periods and 40 ms DRX periods on two adjacent NCT cells having 5 ms transmission cycles.

As illustrated in FIG. 17, it is assumed that the intra-frequency RRM measurement is performed with 2 ms on-duration periods and 40 ms DRX periods on two adjacent NCT c ells having 5 ms transmission cycles. As shown in the left circle of FIG. 17, since there is not TRS transmitted during the on-duration period of DRX cycle, the terminal cannot perform RSRP measurement on the NCT carriers. Therefore, in this case, the on-duration period may be configured to be not less than 5 ms so that at least one TRS is transmitted in an on-duration period.

On the other hand, in order to increase accuracy of measurements, RRM measurement based on multiple CSI-RS resources for a single NCT cell may be considered when CSI-RS based RRM measurement is performed.

Meanwhile, if TRS is transmitted, TRS based RRM measurement may be performed. On the contrary, if TRS is not transmitted, CSI-RS based RRR measurement may be performed. For example, for a synchronized NCT carrier, synchronization information may be transferred through a legacy carrier. Thus, PSS/SSS/TRS may not be transmitted through the synchronization NCT carrier. In this case, CSI-RS based RRM measurement can be used.

FIG. 18 is a diagram showing DM-RS patterns for a normal CP subframe according to an example embodiment of the present invention.

In 1810 and 1802 of FIG. 18, reduced CRS and DM-RS which moves along time axis according to an example embodiment of the present invention are illustrated. The DM-RS moves so as not to overlap with PSS/SSS, and the positions of symbols to which the DM-RS moves may vary according to example embodiments of the present invention.

Referring to 1810, in a DM-RS pattern according to an example embodiment, DM-RS may be mapped onto respective four resource elements of third and fourth symbols of each slot, at a center frequency and both side frequencies of a resource block. Specifically, in the equation 7, for each slot, w(x,y) may be w(3,0), w(4,0), w(3,1), w(4,1), w(3,5), w(4,5), w(3,6), w(4,6), w(3,10), w(4,10), w(3,11), or w(4,11).

Referring to 1820, in a DM-RS pattern according to another example embodiment, DM-RS may be mapped onto respective four resource elements of third and fourth symbols of the first slot at a center frequency and both side frequencies, and mapped onto respective four elements of sixth and seventh symbols of the second slot at the same. Specifically, in the equation 7, for the first slot (nₛ=0), w(x,y) may be w(3,0), w(4,0), w(3,1), w(4,1), w(3,5), w(4,5), w(3,6), w(4,6), w(3,10), w(4,10), w(3,11), or w(4,11). Also, for the second slot (nₛ=1), w(x,y) may be w(5,0), w(6,0), w(5,1), w(6,1), w(5,5), w(6,5), w(5,6), w(6,6), w(5,10), w(6,10), w(5,11), or w(6,11).

In the DM-RS patterns of FIG. 18, DM-RS is mapped onto the third and fourth symbols of the first slot, and the third and fourth symbols or the sixth and seventh symbols of the second slot, in order to evade collisions with PSS/SSS.

FIGS. 19 to 21 illustrate CSI-RS patterns in which CSI-RS is configured.

In FIGS. 19 to 21, CSI-RS is mapped onto resource elements of third and fourth symbols of a second slot.

If CSI-RS is configured at the third and fourth symbols of the second slot as illustrated in FIGS. 19 to 21, the DM-RS pattern 1810 of FIG. 18 may make DM-RS overlap with CSI-RS on the third and fourth symbols of the second slot. Thus, a base station (a transmission point or a serving cell) may schedule CSI-RS not to overlap with DM-RS of the DM-RS pattern 1810 while using the DM-RS pattern 1810.

The DM-RS pattern 1810 may resolve a problem of PSS/SSS overlapping/collision in a NCT carrier where a control region does not exist, and enhance demodulation performance on whole resource block since DM-RS resources are located uniformly in the center of each slot. According to the DM-RS pattern 1810, DM-RS may overlap with CSI-RS in the second slot. However, the base station (transmission point or serving cell) may schedule CSI-RS not to overlap with DM-RS of the DM-RS pattern 1810 while using the DM-RS pattern 1810.

The DM-RS pattern 1820 in FIG. 18 can resolve a problem of overlapping/collision with PSS/SSS as well as a problem of overlapping/collision with CSI-RS in a NCT carrier where a control region does not exist so that the base station (transmission point or serving cell) can freely schedule resources when allocating resources.

FIG. 22 is a diagram showing DM-RS patterns for a normal CP subframe and an extended CP subframe, in case of FDD, according to an example embodiment of the present invention.

Referring to FIG. 22, as illustrated in a DM-RS pattern 2010, for a normal CP subframe, DM-RS may be mapped onto respective four resource elements of first and second symbols of respective slots (first slot (even-numbered slot) and second slot (odd-numbered slot) at a center frequency and both side frequencies. Specifically, in the equation 7, for the first slot (nₛ=0) and second slot (nₛ=1), w(x,y) may be w(0,0), w(1,0), w(0,1), w(1,1), w(0,5), w(1,5), w(0,6), w(1,6), w(0,10), w(1,10), w(0,11), or w(1,11). As shown in 2020, for an extended CP subframe, DM-RS may be mapped onto second, fifth, eighth, and eleventh resource elements of second and third symbols in the first slot, and mapped onto first, fourth, seventh, and tenth resource elements of second and third symbols of the second slot.

In 2010 of FIG. 22, since PSS/SSS is located in sixth and seventh symbols of the first slot, collision with DM-RS does not occur. Also, in 2020 of FIG. 22, since PSS/SSS is located in fifth and sixth symbols of the first slot, collision with DM-RS does not occur.

FIG. 23 and FIG. 24 are diagrams illustrating DM-RS patterns for a normal CP subframe and an extended CP subframe, in case of TDD, according to an example embodiment of the present invention.

As illustrated in FIG. 23 and FIG. 24, in case of TDD, since PSS/SSS is positioned in the last symbol of second slot of a subframe when the subframe is a normal subframe, DM-RS may be mapped onto symbols other than the position (the last symbol of second slot). Similarly, since PSS/SSS is positioned in the third symbol of first slot of a subframe when the subframe is a special subframe, DM-RS may be mapped onto symbols other than the position (the third symbol of first slot).

Referring to FIG. 23 illustrating case of normal CP subframe, since PSS/SSS is positioned at the last symbol of normal subframe and the third symbol of special subframe in case of TDD, a DM-RS pattern may be designed to evade collision with the PSS/SSS. Thus, in case of a normal subframe, DM-RS may be mapped onto respective four resource elements of fifth and sixth symbols of each of the first and second slots at a center frequency and both side frequencies. Also, in case of a special subframe, DM-RS may be mapped onto respective four resource elements of first, second, sixth, and seventh symbols of the first slot at a center frequency and both side frequencies.

Referring to FIG. 24 illustrating case of extended CP subframe, since PSS/SSS is positioned at the last symbol of normal subframe and the third symbol of special subframe in case of TDD, a DM-RS pattern may be designed to evade collision with the PSS/SSS. Thus, in case of a normal subframe, DM-RS may be mapped onto second, fifth, eighth, and eleventh resource elements of second and third symbols of the first slot, and first, fourth, seventh, and tenth resource elements of second and third symbols of the second slot.

Meanwhile, in case of a special subframe, DM-RS may be mapped onto second, fifth, eighth, and eleventh resource elements of fifth and sixth symbols of the first slot.

2. RRM Measurements for NCT

A RRM measurement function for NCT is not for mobility (handover or cell (re)selection) but for performance of transmission points (base stations) in determination of addition or removal of NCT as a SCell based on RRM measurement reports from a terminal. The RRM measurement for NCT may be applied only to RRC-connected terminals not only for inter-frequency measurement but also for intra-frequency measurement. That is, RRM measurement for idle mode is not necessary. The RRM measurements may be applied to both a synchronized NCT and an unsynchronized NCT. Similarly to CA, metrics of RSRP and RSRQ may be defined for NCT RRM measurements. The RRM measurement modes and procedures defined for addition/removal of S Cell in CA may be re-used for NCT as follows.

| | |
|---|---|
| RSRP | Reference signal received power (RSRP), is defined as the linear |
| | average over the power contributions (in [W]) of the resource |
| | elements that carry cell specific reference signals within the |
| | considered measurentent frequency bandwidth. |
| | For RSRP determination the cell specific reference signals R₀ |
| | acs: TS 36.211 [3] shall be used. If the UE can reliably |
| | detect that R₁ is available it may use R₁ in addition to R₀ to |
| | determine RSRP. |
| | The reference point for the RSRP shall be the antenna connector |
| | of the UE. |
| | It receiver diversity is in use by the UE, the reported value shall |
| | not be lower than the corresponding RSRP of any of the |
| | individual diversity branches. |
| RSRQ | Reference Signal Received Quality (RSRQ) is defined as the |
| | ratio N × RSRP/E-UTRA carrier RSSI), where N is the number |
| | at RB's of the E-UTRA carrier RSSI measurement bandwidth. |
| | The measurements in the numerator and denominator shall be |
| | made over the same set of resource blocks. |
| | E-UTRA Carrier Received Signal Strength Indicator (RSSI), |
| | comprises the linear average of the total received power (in |
| | [W] observed only in OFDM symbols containing reference |
| | symbols for antenna port 0, in the measurement bandwidth, |
| | over N number of resource blocks by the UE from all sources, |
| | including co-channel serving and non-serving cells, adjacent |
| | channel interference, thermal noise etc. If higher-layer |
| | signalling indicates certain subframes tor performing RSRQ |
| | measurements, then RSSI is measured over all OFDM symbols |
| | in the indicated subframes. |
| | The reference point for the RSRQ shall be the antenna connector |
| | of the UE. |
| | If receiver diversity is in use by the UE, the reported value shall |
| | not be lower than the corresponding RSRQ of any of the |
| | individual diversity branches. |

According to its definition, a legacy CRS is not transmitted by a NCT carrier. Thus, it may be necessary that other RS is used for RRM measurements for NTC. RS transmission in a NCT carrier includes CSI-RS, DM-RS, and PSS/SSS. For time and frequency synchronization, a NCT carrier may carry 1 RS port (configured with release-8 CRS port 0 REs and release-8 sequence for each PRB) per 1 subframe with 5 ms periodicity.

Among signals transmitted in a NCT carrier, only at least one of CSI-RS and TRS (or, combination of these) can be considered as RS for RRM measurement.

When TRS is used for both synchronized NCT carrier and unsynchronized NCT carrier, TRS can be used as RS for RRM measurement. In this case, identical RRM measurement method may be applied to both synchronized NCT and unsynchronized NCT. In case of periodic TRS transmission, in order to select subframes among TRS subframes for RRM measurements, a terminal should know when TRS is transmitted. For RRM measurement on a serving cell, the terminal should obtain system information such as a cell type (e.g., a legacy cell type (LCT) or a NCT), subframe offset of TRS subframes (if configured), etc. For intra-frequency RRM measurement, information on TRS subframes of adjacent cells cannot be always notified to a terminal. Meanwhile, in case that a terminal is configured to have a measurement object, a measurement request may include cell type information or TRS information of a target cell.

As previously illustrated in FIG. 17, it is assumed that the intra-frequency RRM measurement is performed with 2 ms on-duration periods and 40 ms DRX periods on two adjacent NCT c ells having 5 ms transmission cycles. As shown in the left circle of FIG. 17, since there is not TRS transmitted during the on-duration period of DRX cycle, the terminal cannot perform RSRP measurement on the NCT carriers. Therefore, in this case, the on-duration period may be configured to be not less than 5 ms so that at least one TRS is transmitted in an on-duration period.

On the other hand, in order to increase accuracy of measurements, RRM measurement based on multiple CSI-RS resources for a single NCT cell may be considered when CSI-RS based RRM measurement is performed.

Meanwhile, if TRS is transmitted, TRS based RRM measurement may be performed. On the contrary, if TRS is not transmitted, CSI-RS based RRR measurement may be performed. For example, for a synchronized NCT carrier, synchronization information may be transferred through a legacy carrier. Thus, PSS/SSS/TRS may not be transmitted through the synchronization NCT carrier. In this case, CSI-RS based RRM measurement can be used.

3. Synchronized NCT Carriers

The synchronized NCT carriers may be restricted to only use for intra-band contiguous carrier aggregation using a single RF front end. CRS may be transmitted for RRM measurements without regard to time/frequency tracking Meanwhile, PSS/SSS can be removed.

On the contrary, information or RSs of synchronized NCT carriers for time/frequency synchronization and tracking may be signaled (transmitted/transferred) to a terminal via upper layer signaling. In this case, PSS/SSS/CRS/TRS may not be transmitted through the synchronized NCT carrier.

A segment may be in the same band with a backward compatible carrier (BCC) only for downlink. In this case, the size of the segment may be equal to or less than the BCC. The segment and BCC may be time/frequency-synchronized with each other. PSS/SSS/PBCH/SIBs may not be transmitted in the segment. A single (E)PDCCH DCI indicates BCC and segment. A single HARQ can be used for BCC and segment. The maximum resource allocation size of BCC and segment may be 110 PRB pairs (20 MHz). The segment may support only unicast PDSCH. CRS is transmitted in the segment, and transmission modes (TM) 1-10 are supported. There may be a guard band between BCC and segment. The segment may exist in a single edge of BCC or in both edges of BCC.

Although structures and transmission methods of NCT carriers are explained until now, a base station and a terminal which will be explained hereinafter may operate based on the above-described NCT structures and transmission methods.

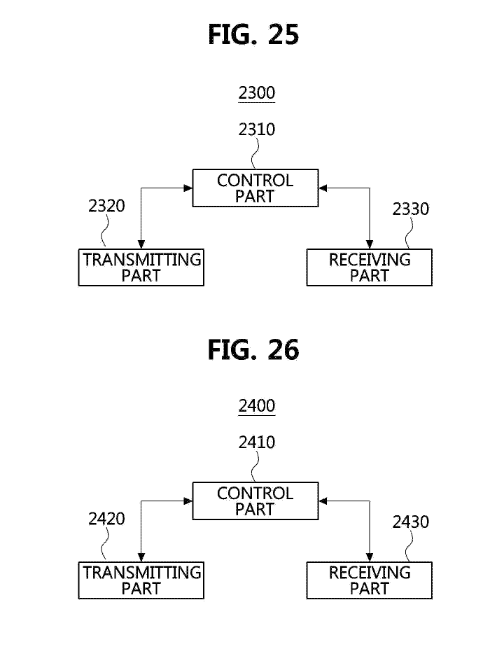

FIG. 25 is a diagram showing a configuration of a base station according to another example embodiment of the present invention. The apparatus in FIG. 25 is an apparatus implementing example embodiments explained through FIG. 15 and FIGS. 18 to 24.

Referring to FIG. 25, a base station 2300 according to another example embodiment of the present invention may comprise a control part 2310, a transmitting part 2320, and a receiving part 2330.

The control part 2310 may control overall operations of the base station according to the above-described structures and operations for a NCT carrier required to perform the present invention.

The transmitting part 2320 and the receiving part 2330 are used for transmitting and receiving signals, messages, and data required for performing the present invention with a terminal.

In further detail, the base station transmits a demodulation reference signal in a NCT carrier. For this, the control part 2310 may map the demodulation reference signal onto symbols which are temporally different from PSS/SSS positioned in a downlink subframe of the carrier. The transmitting part 2320 transmits the downlink subframe including the mapped demodulation reference signal, and the receiving part 2330 receives the downlink subframe from the terminal. The detail example embodiments in which demodulation reference signal is mapped onto temporally-different symbols not to collide with PSS/SSS were previously explained through FIG. 15 and FIGS. 18 to 24.

FIG. 26 is a diagram showing a configuration of user equipment according to another example embodiment of the present invention.

Referring to FIG. 26, the user equipment (i.e., the terminal) 2400 according to another example embodiment of the present invention may comprise a control part 2410, a transmitting part 2420, and a receiving part 2430. The apparatus in FIG. 26 is an apparatus implementing example embodiments explained through FIG. 16 and FIGS. 18 to 24.

The receiving part 2430 may receive downlink control information, data, and messages from a base station through corresponding channels.

Also, the control part 2410 may control overall operations of the terminal according to the above-described structures and operations for a NCT carrier required to perform the present invention.

The transmitting part 2420 may transmit downlink control information, data, and message to the base station through corresponding channels.

In further detail, the receiving part 2430 of the terminal 2400 receives a downlink subframe including a demodulation reference signal, and the control part 2410 identifies the demodulation reference signal mapped onto symbols which are temporally-different from PSS/SSS located in the downlink subframe of the carrier. Then, the transmitting part 2420 transmits signals. The example embodiments of the demodulation reference signal mapped on to the symbols may be referred to exampled embodiments explained through FIG. 16 and FIGS. 18 to 24.

In addition to the above-described method of changing mapping positions of DM-RS to evade collisions, a method of mapping DM-RS onto frequency bands other than a frequency band to which PSS/SSS is allocated may be considered. For example, in case that PSS/SSS is allocated to six RBs in the center frequency, DM-RS to be mapped onto the same position can be mapped onto other frequency band in the same time axis, e.g., a frequency band adjacent to the band on which the PSS/SSS is mapped. That is, when PSS/SSS is mapped on 6 RBs in the center frequency, DM-RS can be mapped onto RBs in a frequency band adjacent to the band of PSS/SSS.

Also, as described above, a method of puncturing DM-RS in a frequency band where collisions between DM-RS and PSS/SSS occur may be considered. On the contrary, a method of puncturing PSS/SSS may also be considered.

In the various example embodiments of the present invention, interferences between two signals can be removed by moving time axis of DM-RS while maintaining frequency positions of DM-RS, moving frequency positions of DM-RS while maintaining time axis of DM-RS, or puncturing DM-RS or PSS/SSS while maintaining both frequency positions and time axes of two signals.

As described above, since the technical idea of the present invention is described by exemplary embodiments, various forms of substitutions, modifications and alterations may be made by those skilled in the art from the above description without departing from essential features of the present invention. Therefore, the embodiments disclosed in the present invention are intended to illustrate the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of transmitting a demodulation reference signal having orthogonality in a new carrier type (NCT) carrier, performed by a base station, the method comprising:
performing code division multiplexing on a demodulation reference signal to be mapped onto a symbol overlapped with a Primary Synchronization Signal (PSS) and a Secondary Synchronization Signal (SSS) positioned in a downlink subframe of the carrier by using an orthogonal code; and
transmitting the demodulation signal to which the code division multiplexing is applied through downlink.

2. The method of claim 1, further comprising transmitting information indicating the orthogonal code as included in a Radio Resource Control (RRC) message.

3. The method of claim 1, further comprising transmitting information of two or more orthogonal code groups including the orthogonal code as included in a Radio Resource Control (RRC) message.

4. The method of claim 1, wherein the orthogonal code is one of orthogonal sequences included in the following table.

| Antenna port p | [ w̅ₚ (0) w̅ₚ (1 ) w̅ₚ(2) w̅ₚ(3)] |
|---|---|
| 7 | [+1 +1 +1 +1] |
| 8 | [+1 −1 +1 −1] |
| 9 | [+1 +1 +1 +1] |
| 10 | [+1 −1 +1 −1] |
| 11 | [+1 +1 −1 −1] |
| 12 | [−1 −1 +1 +1] |
| 13 | [+1 −1 −1 +1] |
| 14 | [−1 +1 +1 −1] |

5. A method of receiving a demodulation reference signal having orthogonality in a new carrier type carrier, performed by a terminal, the method comprising:
receiving a downlink subframe including the demodulation reference signal; and
identifying the demodulation reference signal located in the downlink subframe of the carrier by using an orthogonal code,
wherein the demodulation reference signal is mapped onto a symbol overlapped with a Primary Synchronization Signal (PSS) and a Secondary Synchronization Signal (SSS) positioned in the downlink subframe of the carrier, and the PSS, the SSS, and the demodulation reference signal are code-division-multiplexed.

6. The method of claim 5, further comprising receiving a Radio Resource Control (RRC) message including information indicating the orthogonal code.

7. The method of claim 5, wherein the identifying further comprises blind-decoding the demodulation reference signal by using a plurality of orthogonal codes.

8. The method of claim 7, further comprising receiving a Radio Resource Control (RRC) message which includes information of a code group including the plurality of orthogonal codes to be used in the blind-decoding.

9. The method of claim 5, wherein the orthogonal code is one of orthogonal sequences shown in the following table.

| Antenna port p | [ w̅ₚ (0) w̅ₚ (1 ) w̅ₚ(2) w̅ₚ(3)] |
|---|---|
| 7 | [+1 +1 +1 +1] |
| 8 | [+1 −1 +1 −1] |
| 9 | [+1 +1 +1 +1] |
| 10 | [+1 −1 +1 −1] |
| 11 | [+1 +1 −1 −1] |
| 12 | [−1 −1 +1 +1] |
| 13 | [+1 −1 −1 +1] |
| 14 | [−1 +1 +1 −1] |

10. A base station transmitting a demodulation reference signal having orthogonality in a new carrier type (NCT) carrier, the base station comprising:
a receiving part receiving signals from a terminal;
a control part performing a code division multiplexing using a orthogonal code on a demodulation reference signal mapping to a symbol overlapped with a Primary Synchronization Signal (PSS) and a Secondary Synchronization Signal (SSS) positioned in a downlink subframe of the NCT carrier; and
a transmitting part transmitting the downlink subframe to which the code division multiplexing is applied.

11. A method of transmitting a demodulation reference signal in a new carrier type carrier, performed by a base station, the method comprising:
mapping the demodulation reference signal onto a symbol which are temporally different from a Primary Synchronization Signal (PSS) and a Secondary Synchronization Signal (SSS) positioned in a downlink subframe of the carrier; and
transmitting the downlink subframe including the demodulation reference signal.

12. The method of claim 11, wherein the downlink subframe comprises two slots, and the demodulation reference signal is positioned at third and fourth symbols in the respective two slots, or at third and fourth symbols of a first slot and at sixth and seventh symbols of a second slot.

13. The method of claim 11, further comprising re-scheduling a Channel State Information Reference Signal (CSI-RS) when the CSI-RS of the downlink subframe overlaps with the demodulation reference signal.

14. The method of claim 11, wherein the downlink subframe comprises two slots in a Frequency Division Duplexing (FDD) manner, the demodulation reference signal is positioned at first and second symbols in the respective two slots when the subframe is a normal cyclic prefix (CP) subframe, and the demodulation reference signal is positioned at second and third symbols in the respective two slots when the subframe is an extended CP subframe.

15. The method of claim 11, wherein the downlink subframe comprises two slots in a Time Division Duplexing (TDD) manner, the demodulation reference signal is positioned at a symbol other than a last symbol of a second slot of the subframe when the subframe is a normal CP subframe, and the demodulation reference signal is positioned at a symbol other than a third symbol of a first slot of the subframe when the subframe is an extended CP subframe.

16. A method of receiving a demodulation reference signal having orthogonality in a new carrier type carrier, performed by a terminal, the method comprising:
receiving a downlink subframe including the demodulation reference signal; and
identifying the demodulation reference signal mapped onto symbols which are temporally different from a Primary Synchronization Signal (PSS) and a Secondary Synchronization Signal (SSS) positioned in the downlink subframe of the carrier.

17. The method of claim 16, wherein the downlink subframe comprises two slots, the demodulation reference signal is positioned in third and fourth symbols in the respective two slots, or the demodulation reference signal is positioned in third and fourth symbols of the first slot and sixth and seventh symbols of the second slot.

18. The method of claim 16, wherein a Channel State Information Reference Signal (CSI-RS) of the downlink subframe is re-scheduled when the CSI-RS overlaps with the demodulation reference signal.

19. The method of claim 16, wherein the downlink subframe comprises two slots in a Frequency Division Duplexing (FDD) manner, the demodulation reference signal is positioned in first and second symbols in the respective two slots when the subframe is a normal cyclic prefix subframe, and the demodulation reference signal is positioned in second and third symbols in the respective two slots when the subframe is an extended cyclic prefix subframe.

20. The method of claim 16, wherein the downlink subframe comprises two slots in a Time Division Duplexing (TDD) manner, the demodulation reference signal is positioned in a symbol other than a last symbol of a second slot of the subframe when the subframe is a normal cyclic prefix subframe, and the demodulation reference signal is positioned in a symbol other than a third symbol of a first slot of the subframe when the subframe is an extended cyclic prefix subframe.

21. A base station transmitting a demodulation reference signal in a new carrier type carrier, the base station comprising:
a control part mapping the demodulation reference signal onto symbols which are temporally different from a Primary Synchronization Signal (PSS) and a Secondary Synchronization Signal (SSS) positioned in a downlink subframe of the carrier;
a transmitting part transmitting the downlink subframe including the mapped demodulation reference signal; and
a receiving part receiving signals from a terminal receiving the downlink subframe.
